(19) United States
(12) Patent Application Publication
(10) Pub. No.: US 2024/0321280 A1
(43) Pub. Date: Sep. 26, 2024

(54) ENCODING DEVICE AND METHOD, DECODING DEVICE AND METHOD, AND PROGRAM

(71) Applicant: Sony Group Corporation, Tokyo (JP)

(72) Inventors: Akifumi Kono, Tokyo (JP); Toru Chinen, Kanagawa (JP); Hiroyuki Honma, Chiba (JP); Mitsuyuki Hatanaka, Kanagawa (JP)

(73) Assignee: Sony Group Corporation, Tokyo (JP)

(21) Appl. No.: 18/577,225

(22) PCT Filed: Jul. 8, 2022
(86) PCT No.: PCT/JP2022/027053

§ 371 Date: Jan. 5, 2024

(30) Foreign Application Priority Data
Jul. 12, 2021 (JP) 2021-115100
Feb. 2, 2022 (JP) 2022-014722

(51) Int. Cl. G10L 19/002; G10L 19/012; G10L 19/032

(52) U.S. Cl. CPC G10L 19/002; G10L 19/012; G10L 19/032

(57) ABSTRACT

The present technology relates to an encoding device and method, a decoding device and method, and a program that enable to improve an encoding efficiency in a state where a real-time operation is maintained.

The encoding device includes a priority information generation unit that generates priority information indicating a priority of an audio signal, on the basis of at least one of the audio signal or metadata of the audio signal, a time-frequency transform unit that performs time-frequency transform on the audio signal and generates an MDCT coefficient, and a bit allocation unit that quantizes the MDCT coefficient of the audio signal, in descending order of the priority of the audio signal indicated by the priority information, for a plurality of the audio signals. The present technology may be applied to the encoding device.

### TECHNICAL FIELD

The present technology relates to an encoding device and method, a decoding device and method, and a program, and more particularly, relates to an encoding device and method, a decoding device and method, and a program that enable to improve an encoding efficiency in a state where a real-time operation is maintained.

### BACKGROUND ART

Typically, encoding techniques compliant with the moving picture experts group (MPEG)-D unified speech and audio coding (USAC) standard that is an international standard and the MPEG-H 3D Audio standard that is Core Coder of the MPEG-D USAC standard or the like have been known (for example, refer to Non-Patent Documents 1 to 3).

### CITATION LIST

### Non-Patent Document

Non-Patent Document 1: ISO/IEC 23003-3, MPEG-D USAC
Non-Patent Document 2: ISO/IEC 23008-3, MPEG-H 3D Audio
Non-Patent Document 3: ISO/IEC 23008-3:2015/AMENDMENT3, MPEG-H 3D Audio Phase 2

### SUMMARY OF THE INVENTION

### Problems to be Solved by the Invention

In the 3D Audio handled in the MPEG-H 3D Audio standard or the like, metadata for each object such as a horizontal angle and a vertical angle indicating a position of a sound material (object), a distance, or a gain for the object is held, and a three-dimensional sound direction, distance, spread, or the like can be reproduced. Therefore, with the 3D Audio, it is possible to perform audio reproduction with more realistic feeling, than typical stereo reproduction.

However, in order to transmit data of a large number of objects implemented by the 3D Audio, an encoding technology is needed that can decode more audio channels with high compression efficiency and at high speed. That is, it is desired to improve an encoding efficiency.

Moreover, in order to perform live stream of a live or a concert with the 3D Audio, it is necessary to achieve both of the improvement in the encoding efficiency and real-time performance.

The present technology has been made in consideration of such a situation, and is intended to improve an encoding efficiency in a state where a real-time operation is maintained.

### Solutions to Problems

An encoding device according to a first aspect of the present technology includes a priority information generation unit that generates priority information indicating a priority of an audio signal, on the basis of at least one of the audio signal or metadata of the audio signal, a time-frequency transform unit that performs time-frequency transform on the audio signal and generates an MDCT coefficient, and a bit allocation unit that quantizes the MDCT coefficient of the audio signal, in descending order of the priority of the audio signal indicated by the priority information, for a plurality of the audio signals.

An encoding method or a program according to the first aspect of the present technology includes steps of generating priority information indicating a priority of an audio signal, on the basis of at least one of the audio signal or metadata of the audio signal, performing time-frequency transform on the audio signal and generating an MDCT coefficient, and quantizing the MDCT coefficient of the audio signal, in descending order of the priority of the audio signal indicated by the priority information, for a plurality of the audio signals.

In the first aspect of the present technology, priority information indicating a priority of an audio signal is generated on the basis of at least one of the audio signal or metadata of the audio signal, time-frequency transform is performed on the audio signal, an MDCT coefficient is generated, and the MDCT coefficient of the audio signal is quantized in descending order of the priority of the audio signal indicated by the priority information, for a plurality of the audio signals.

A decoding device according to a second aspect of the present technology includes a decoding unit that acquires an encoded audio signal obtained by quantizing an MDCT coefficient of an audio signal, in descending order of a priority of the audio signal indicated by priority information generated on the basis of at least one of the audio signal or metadata of the audio signal, for a plurality of the audio signals, and decodes the encoded audio signal.

A decoding method or a program according to the second aspect of the present technology includes steps of acquiring an encoded audio signal obtained by quantizing an MDCT coefficient of an audio signal, in descending order of a priority of the audio signal indicated by priority information generated on the basis of at least one of the audio signal or metadata of the audio signal, for a plurality of the audio signals, and decoding the encoded audio signal.

In the second aspect of the present technology, an encoded audio signal is acquired that is obtained by quantizing an MDCT coefficient of an audio signal in descending order of a priority of the audio signal indicated by priority information generated on the basis of at least one of the audio signal or metadata of the audio signal, for a plurality of the audio signals, and the encoded audio signal is decoded.

An encoding device according to a third aspect of the present technology includes an encoding unit that encodes an audio signal and generates an encoded audio signal, a buffer that holds a bit stream including the encoded audio signal for each frame, and an insertion unit that inserts encoded silent data generated in advance into the bit stream, as the encoded audio signal of a frame to be processed, in a case where processing for encoding the audio signal within a predetermined time is not completed, for the frame to be processed.

An encoding method or a program according to the third aspect of the present technology includes steps for encoding an audio signal and generating an encoded audio signal, holding a bit stream including the encoded audio signal for each frame in a buffer, and inserting encoded silent data generated in advance into the bit stream as the encoded audio signal of a frame to be processed, in a case where processing for encoding the audio signal is not completed with a predetermined time, for the frame to be processed.

In the third aspect of the present technology, an audio signal is encoded, and an encoded audio signal is generated, a bit stream including the encoded audio signal for each frame is held in a buffer, and encoded silent data generated in advance is inserted into the bit stream as the encoded audio signal of a frame to be processed, in a case where processing for encoding the audio signal is not completed with a predetermined time, for the frame to be processed.

A decoding device according to a fourth aspect of the present technology includes a decoding unit that encodes an audio signal and generates an encoded audio signal, acquires a bit stream obtained by inserting encoded silent data generated in advance, as the encoded audio signal of a frame to be processed into the bit stream including the encoded audio signal for each frame, in a case where the processing for encoding the audio signal is not completed within a predetermined time, for the frame to be processed, and decodes the encoded audio signal.

A decoding method or a program according to the fourth aspect of the present technology includes steps for encoding an audio signal and generating an encoded audio signal, acquiring a bit stream obtained by inserting encoded silent data generated in advance, as the encoded audio signal of a frame to be processed into the bit stream including the encoded audio signal for each frame, in a case where the processing for encoding the audio signal is not completed within a predetermined time, for the frame to be processed, and decoding the encoded audio signal.

In the fourth aspect of the present technology, an audio signal is encoded and an encoded audio signal is generated, a bit stream is acquired that is obtained by inserting encoded silent data generated in advance as the encoded audio signal of a frame to be processed into the bit stream including the encoded audio signal for each frame, in a case where the processing of encoding the audio signal is not completed within a predetermined time, for the frame to be processed, and the encoded audio signal is decoded.

An encoding device according to a fifth aspect of the present technology includes a time-frequency transform unit that performs time-frequency transform on an audio signal of an object and generates an MDCT coefficient, an auditory psychological parameter calculation unit that calculates an auditory psychological parameter on the basis of the MDCT coefficient and setting information regarding a masking threshold for the object, and a bit allocation unit that executes bit allocation processing on the basis of the auditory psychological parameter and the MDCT coefficient and generates a quantized MDCT coefficient.

An encoding method or a program according to the fifth aspect of the present technology includes steps for performing time-frequency transform on an audio signal of an object and generating an MDCT coefficient, calculating an auditory psychological parameter on the basis of the MDCT coefficient and setting information regarding a masking threshold for the object, and executing bit allocation processing on the basis of the auditory psychological parameter and the MDCT coefficient and generating a quantized MDCT coefficient.

In the fifth aspect of the present technology, time-frequency transform is performed on an audio signal of an object and an MDCT coefficient is generated, an auditory psychological parameter is calculated on the basis of the MDCT coefficient and setting information regarding a masking threshold for the object, and bit allocation processing is executed on the basis of the auditory psychological parameter and the MDCT coefficient and a quantized MDCT coefficient is generated.

### BRIEF DESCRIPTION OF DRAWINGS

FIG. 1 is a diagram illustrating a configuration example of an encoder.

FIG. 2 is a diagram illustrating a configuration example of an object audio encoding unit.

FIG. 3 is a flowchart for describing encoding processing.

FIG. 4 is a flowchart for describing bit allocation processing.

FIG. 5 is a diagram illustrating a syntax example of Config of metadata.

FIG. 6 is a diagram illustrating a configuration example of a decoder.

FIG. 7 is a diagram illustrating a configuration example of an unpacking/decoding unit.

FIG. 8 is a flowchart for describing decoding processing.

FIG. 9 is a flowchart for describing selection decoding processing.

FIG. 10 is a diagram illustrating a configuration example of the object audio encoding unit.

FIG. 11 is a diagram illustrating a configuration example of a content distribution system.

FIG. 12 is a diagram for describing an example of input data.

FIG. 13 is a diagram for describing context calculation.

FIG. 14 is a diagram illustrating a configuration example of the encoder.

FIG. 15 is a diagram illustrating a configuration example of the object audio encoding unit.

FIG. 16 is a diagram illustrating a configuration example of an initialization unit.

FIG. 17 is a diagram for describing an example of progress information and processing completion availability determination.

FIG. 18 is a diagram for describing an example of a bit stream including coded data.

FIG. 19 is a diagram illustrating a syntax example of the coded data.

FIG. 20 is a diagram illustrating an example of extension data.

FIG. 21 is a diagram for describing segment data.

FIG. 22 is a diagram illustrating a configuration example of AudioPreRoll( ).

FIG. 23 is a flowchart for describing initialization processing.

FIG. 24 is a flowchart for describing encoding processing.

FIG. 25 is a flowchart for describing encoded Mute data insertion processing.

FIG. 26 is a diagram illustrating a configuration example of the unpacking/decoding unit.

FIG. 27 is a flowchart for describing the decoding processing.

FIG. 28 is a diagram illustrating a configuration example of the encoder.

FIG. 29 is a diagram illustrating a configuration example of the object audio encoding unit.

FIG. 30 is a flowchart for describing the encoding processing.

FIG. 31 is a diagram illustrating a configuration example of a computer.

### MODE FOR CARRYING OUT THE INVENTION

Hereinafter, embodiments to which the present technology has been applied will be described with reference to the drawings.

### First Embodiment

### <About Present Technology>

The present technology executes encoding processing in consideration of an importance of an object (sound) so as to improve an encoding efficiency in a state where a real-time operation is maintained and to increase the number of transmittable objects.

For example, it is required to execute the encoding processing as actual time processing, in order to realize live stream. That is, in a case where sound of f frames is distributed in one second, encoding of one frame and bit stream output need to be completed within 1/f seconds.

In this way, in order to achieve a goal that the encoding processing is executed as the actual time processing, the following approach is effective.
The encoding processing is executed in a stepwise manner.

First, minimum encoding is completed, and additional encoding processing with an increased encoding efficiency is executed thereafter. In a case where the additional encoding processing is not completed at the time when a predetermined time limit set in advance has elapsed, the processing is terminated at that time, and a result of the encoding processing at an immediately preceding stage is output.
Moreover, in a case where minimum encoding is not completed at the time when the predetermined time limit has passed, the processing is terminated, and a bit stream of Mute data prepared in advance is output.

By the way, in a case where audio signals of a multichannel or a plurality of objects are reproduced at the same time, sound reproduced using these audio signals include important sound as compared with other sounds and sound that is not so important. For example, the unimportant sound is sound or the like that, even if specific sound in entire sound is not reproduced, does not make a listener to feel uncomfortable due to that.

If the additional encoding processing with an increased encoding efficiency in a processing order in which an importance of sound, that is, an importance of a channel or an object is not considered, there is a case where the processing is terminated and a sound quality is deteriorated although the sound is important sound.

Therefore, in the present technology, by executing the additional encoding processing with an increased encoding efficiency in the order of the importance of the sound, the encoding efficiency of the entire content can be improved in a state where the real-time operation is maintained.

In this way, the additional encoding processing is completed for the sound with higher importance, and the additional encoding processing is not completed and only the minimum encoding is performed on sound with lower importance. Therefore, it is possible to improve the encoding efficiency of the entire content. As a result, the number of objects that can be transmitted can be increased.

As described above, according to the present technology, the additional encoding processing with an increased encoding efficiency is executed in descending order of a priority of an audio signal of each channel and an audio signal of each object, in encoding of the audio signal of each channel included in the multichannel and the audio signal of the object. As a result, it is possible to improve the encoding efficiency of the entire content in the actual time processing.

Note that, in the following description, a case will be described where the audio signal of the object is encoded according to the MPEG-H standard. However, similar processing is executed in a case where encoding is performed according to the MPEG-H standard including an audio signal of a channel or in a case where encoding is performed by another method.

### <Configuration Example of Encoder>

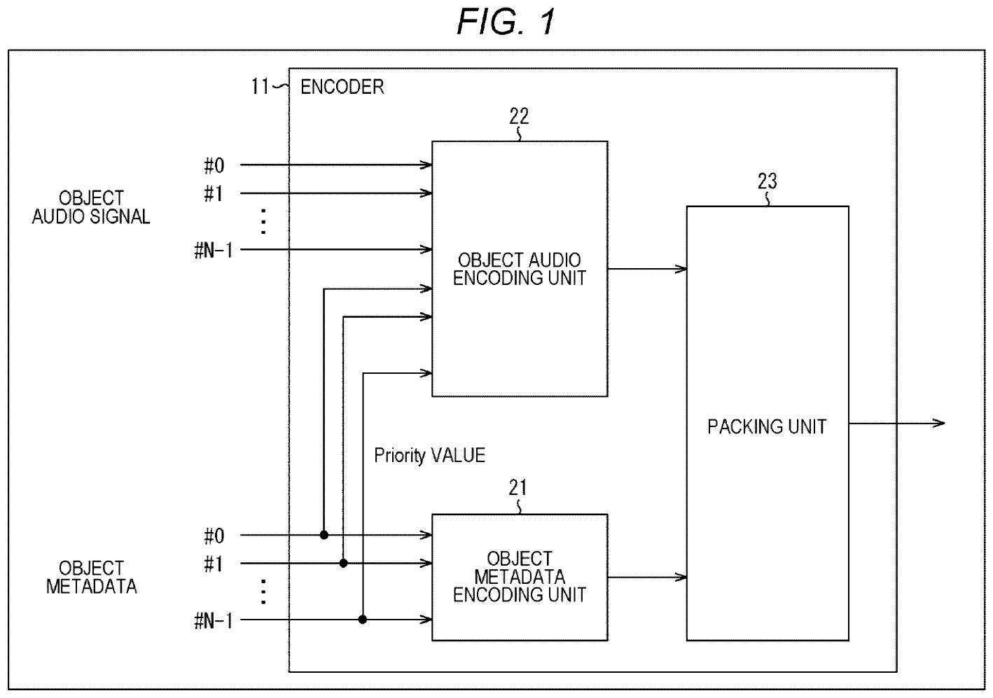

FIG. 1 is a diagram illustrating a configuration example of an embodiment of an encoder to which the present technology is applied.

An encoder 11 illustrated in FIG. 1 includes a signal processing device or the like such as a computer that functions as an encoder (encoding device), for example.

The example illustrated in FIG. 1 is an example in which audio signals of N objects and metadata of the N objects are input to the encoder 11, and encoding is performed compliant with the MPEG-H standard. Note that, in FIG. 1, #0 to #N−1 represent object numbers respectively indicating the N objects.

The encoder 11 includes an object metadata encoding unit 21, an object audio encoding unit 22, and a packing unit 23.

The object metadata encoding unit 21 encodes the supplied metadata of each of the N objects compliant with the MPEG-H standard, and supplies encoded metadata obtained as a result to the packing unit 23.

For example, the metadata of the object includes object position information indicating a position of an object in a three-dimensional space, a Priority value indicating a priority (degree of importance) of the object, and a gain value indicating a gain for gain correction of the audio signal of the object. In particular, in this example, the metadata includes at least the Priority value.

Here, the object position information includes, for example, a horizontal angle (Azimuth), a vertical angle (Elevation), and a distance (Radius).

The horizontal angle and the vertical angle are angles in the horizontal direction and the vertical direction indicating a position of an object viewed from a listening position serving as a reference in the three-dimensional space. Furthermore, the distance (Radius) indicates a distance from the listening position to be the reference, indicating the position of the object in the three-dimensional space, to the object. It can be said that such object position information is information indicating a sound source position of sound based on the audio signal of the object.

In addition, the metadata of the object may include a parameter for spread processing of spreading a sound image of the object, or the like.

The object audio encoding unit 22 encodes the supplied audio signal of each of the N objects compliant with the MPEG-H standard, on the basis of the Priority value included in the supplied metadata of each object and supplies an encoded audio signal obtained as a result to the packing unit 23.

The packing unit 23 packs the encoded metadata supplied from the object metadata encoding unit 21 and the encoded audio signal supplied from the object audio encoding unit 22 and outputs an encoded bit stream obtained as a result.

### <Configuration Example of Object Audio Encoding Unit>

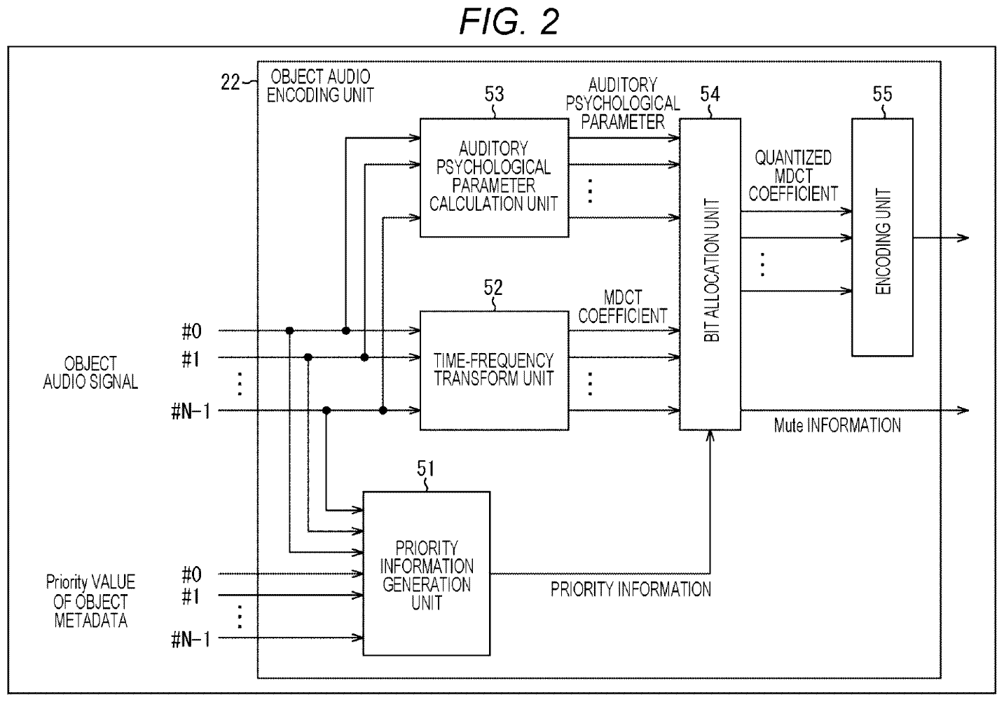

Furthermore, the object audio encoding unit 22 is configured as illustrated in FIG. 2, for example.

In the example in FIG. 2, the object audio encoding unit 22 includes a priority information generation unit 51, a time-frequency transform unit 52, an auditory psychological parameter calculation unit 53, a bit allocation unit 54, and an encoding unit 55.

The priority information generation unit 51 generates priority information indicating a priority of each object, that is, a priority of an audio signal, on the basis of at least one of the supplied audio signal of each object or the Priority value included in the supplied metadata of each object and supplies the priority information to the bit allocation unit 54.

For example, the priority information generation unit 51 analyzes the priority of the audio signal of the object, on the basis of a sound pressure or a spectral shape of the audio signal, a correlation between the spectral shapes of the audio signals of the plurality of objects and the channels, or the like. Then, the priority information generation unit 51 generates the priority information on the basis of the analysis result.

Furthermore, for example, the metadata of the object of the MPEG-H includes the Priority value that is a parameter indicating the priority of the object, as a 3-bit integer from zero to seven, and the larger Priority value represents an object with higher priority.

Regarding the Priority value, there may be a case where a content creator intentionally sets the Priority value or there may be a case where an application for generating metadata analyzes the audio signal of each object so as to automatically set the Priority value. Furthermore, with no intention of the content creator and no analysis on the audio signal, as a default of an application, for example, a fixed value such as the highest priority “7” may be set as the Priority value.

Therefore, when the priority information generation unit 51 generates the priority information of the object (audio signal), only the analysis result of the audio signal may be used without using the Priority value, and both of the Priority value and the analysis result may be used.

For example, in a case where both of the Priority value and the analysis result are used, even if the analysis result of the audio signal is the same, a priority of an object having a larger (higher) Priority value can be set to be higher.

The time-frequency transform unit 52 performs time-frequency transform using modified discrete cosine transform (MDCT) on the supplied audio signal of each object.

The time-frequency transform unit 52 supplies an MDCT coefficient that is frequency spectrum information of each object, obtained through time-frequency transform, to the bit allocation unit 54.

The auditory psychological parameter calculation unit 53 calculates an auditory psychological parameter used to consider auditory characteristics (auditory masking) of a human, on the basis of the supplied audio signal of each object and supplies the auditory psychological parameter to the bit allocation unit 54.

The bit allocation unit 54 executes bit allocation processing, on the basis of the priority information supplied from the priority information generation unit 51, the MDCT coefficient supplied from the time-frequency transform unit 52, and the auditory psychological parameter supplied from the auditory psychological parameter calculation unit 53.

In the bit allocation processing, bit allocation based on an auditory psychological model for calculating and evaluating a quantized bit and a quantization noise of each scale factor band is performed. Then, the MDCT coefficient is quantized for each scale factor band on the basis of a result of the bit allocation, and a quantized MDCT coefficient is obtained.

The bit allocation unit 54 supplies the quantized MDCT coefficient for each scale factor band of each object obtained in this way to the encoding unit 55, as a quantization result of each object, more specifically, a quantization result of the MDCT coefficient of each object.

Here, the scale factor band is a band (frequency band) obtained by bundling a plurality of subbands (here, resolution of MDCT) with a predetermined bandwidth on the basis of the human auditory characteristics.

Through the bit allocation processing as described above, a part of quantized bits of a scale factor band in which the quantization noise that is generated in quantization of the MDCT coefficient is masked and is not perceived is allocated (assigned) to a scale factor band in which the quantization noise is easily perceived. As a result, deterioration in the sound quality as a whole is suppressed, and it is possible to perform efficient quantization. That is, the encoding efficiency can be improved.

Note that the bit allocation unit 54 supplies Mute data, which has been prepared in advance, of an object of which a quantized MDCT coefficient cannot be obtained within the time limit for the actual time processing to the encoding unit 55, as the quantization result of the object.

The Mute data is zero data indicating a value “0” of the MDCT coefficient of each scale factor band, and more specifically, a quantized value of the Mute data, that is, a quantized MDCT coefficient of the MDCT coefficient “0” is output to the encoding unit 55. Note that, here, the Mute data is output to the encoding unit 55. However, instead of supplying the Mute data, Mute information indicating whether or not the quantization result (quantized MDCT coefficient) is the Mute data may be supplied to the encoding unit 55. In that case, the encoding unit 55 switches whether to execute normal encoding processing or to directly encode the quantized MDCT coefficient of the MDCT coefficient “0”, in accordance with the Mute information. Moreover, instead of encoding the quantized MDCT coefficient of the MDCT coefficient “0”, encoded data of the MDCT coefficient “0” that has been prepared in advance may be used.

Furthermore, the bit allocation unit 54 supplies the Mute information indicating whether or not the quantization result (quantized MDCT coefficient) is the Mute data to the packing unit 23, for example, for each object. The packing unit 23 stores the Mute information supplied from the bit allocation unit 54 in an ancillary region of the encoded bit stream or the like.

The encoding unit 55 encodes the quantized MDCT coefficient for each scale factor band of each object supplied from the bit allocation unit 54 and supplies an encoded audio signal obtained as a result, to the packing unit 23.

### <Description of Encoding Processing>

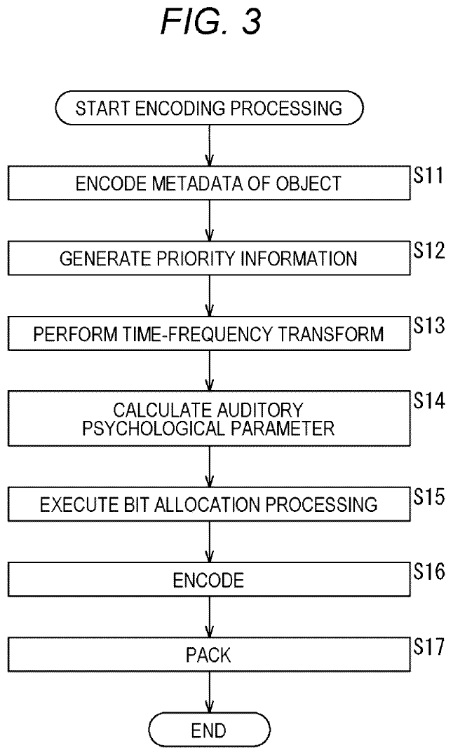

Subsequently, an operation of the encoder 11 will be described. That is, hereinafter, the encoding processing by the encoder 11 will be described with reference to the flowchart in FIG. 3.

In step S11, the object metadata encoding unit 21 encodes the supplied metadata of each object and supplies encoded metadata obtained as a result, to the packing unit 23.

In step S12, the priority information generation unit 51 generates the priority information on the basis of at least one of the supplied audio signal of each object or the Priority value of the supplied metadata of each object and supplies the priority information to the bit allocation unit 54.

In step S13, the time-frequency transform unit 52 performs time-frequency transform using the MDCT on the supplied audio signal of each object and supplies the MDCT coefficient for each scale factor band obtained as a result, to the bit allocation unit 54.

In step S14, the auditory psychological parameter calculation unit 53 calculates the auditory psychological parameter on the basis of the supplied audio signal of each object and supplies the auditory psychological parameter to the bit allocation unit 54.

In step S15, the bit allocation unit 54 executes the bit allocation processing, on the basis of the priority information supplied from the priority information generation unit 51, the MDCT coefficient supplied from the time-frequency transform unit 52, and the auditory psychological parameter supplied from the auditory psychological parameter calculation unit 53.

The bit allocation unit 54 supplies the quantized MDCT coefficient obtained through the bit allocation processing to the encoding unit 55 and supplies the Mute information to the packing unit 23. Note that details of the bit allocation processing will be described later.

In step S16, the encoding unit 55 encodes the quantized MDCT coefficient supplied from the bit allocation unit 54 and supplies the encoded audio signal obtained as a result to the packing unit 23.

For example, the encoding unit 55 performs context-based arithmetic coding on the quantized MDCT coefficient and outputs the encoded quantized MDCT coefficient to the packing unit 23 as the encoded audio signal. Note that the encoding method is not limited to the arithmetic coding. For example, encoding may be performed using the Huffman coding or other encoding methods.

In step S17, the packing unit 23 packs the encoded metadata supplied from the object metadata encoding unit 21 and the encoded audio signal supplied from the encoding unit 55.

At this time, the packing unit 23 stores the Mute information supplied from the bit allocation unit 54 in the ancillary region of the encoded bit stream or the like. Then, the packing unit 23 outputs the encoded bit stream obtained by packing and ends the encoding processing.

As described above, the encoder 11 generates the priority information on the basis of the audio signal of the object and the Priority value and executes the bit allocation processing using the priority information. In this way, the encoding efficiency of the entire content in the actual time processing is improved, and more object data can be transmitted.

### <Description of Bit Allocation Processing>

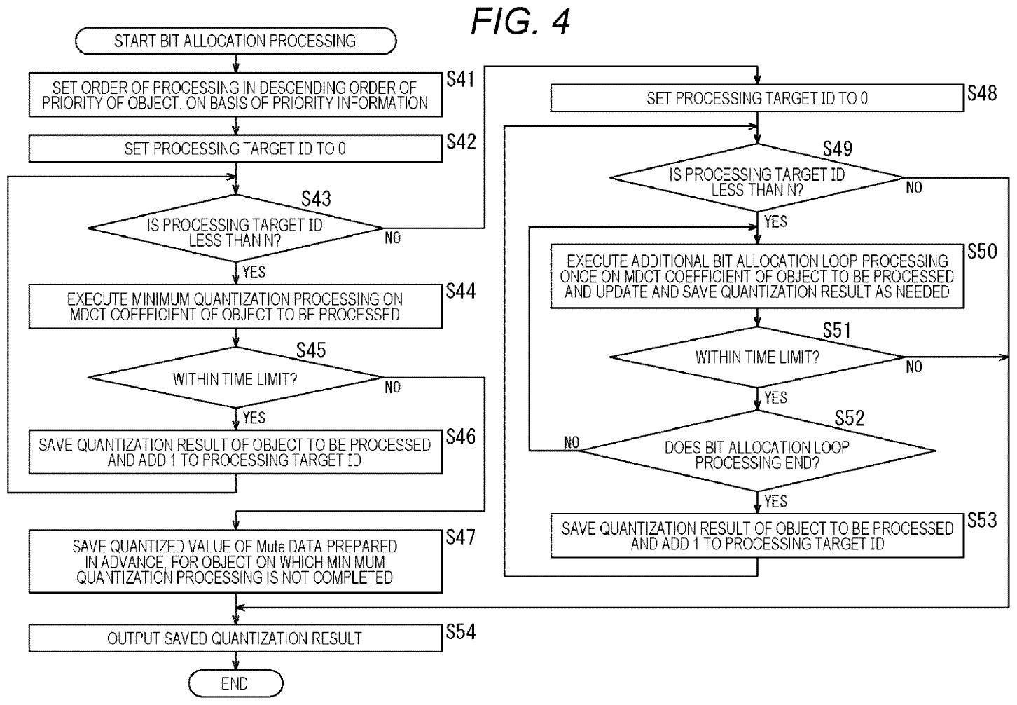

Next, the bit allocation processing corresponding to the processing in step S15 in FIG. 3 will be described with reference to the flowchart in FIG. 4.

In step S41, the bit allocation unit 54 sets an order (processing order) of the processing of each object, in descending order of the priority of the object indicated by the priority information, on the basis of the priority information supplied from the priority information generation unit 51.

In this example, a processing order of an object with the highest priority, among the N objects in total, is set to be “0”, and a processing order of an object with the lowest priority is set to be “N−1”. Note that setting of the processing order is not limited to this. For example, the processing order of the object with the highest priority may be set to “1”, and the processing order of the object with the lowest priority may be set to “N”, and the priority may be represented by a symbol other than numbers.

Hereinafter, minimum quantization processing, that is, minimum encoding processing is executed in order from the object with the higher priority.

That is, in step S42, the bit allocation unit 54 sets a processing target ID indicating an object to be processed to “0”.

The value of the processing target ID is incremented by one from “0” and is updated. Furthermore, when the value of the processing target ID is set to be n, an object indicated by the processing target ID is an n-th object in the processing order set in step S41.

Therefore, the bit allocation unit 54 processes each object in the processing order set in step S41.

In step S43, the bit allocation unit 54 determines whether or not the value of the processing target ID is less than N.

In a case where it is determined in step S43 that the value of the processing target ID is less than N, that is, in a case where quantization processing is not executed on all the objects yet, processing in step S44 is executed.

That is, in step S44, the bit allocation unit 54 executes minimum quantization processing on the MDCT coefficient for each scale factor band of the object to be processed indicated by the processing target ID.

Here, the minimum quantization processing is first quantization processing executed before bit allocation loop processing.

Specifically, the bit allocation unit 54 calculates and evaluates the quantized bit and the quantization noise of each scale factor band, on the basis of the auditory psychological parameter and the MDCT coefficient. As a result, a target bit depth (quantized bit depth) of the quantized MDCT coefficient is determined, for each scale factor band.

The bit allocation unit 54 quantizes the MDCT coefficient for each scale factor band so that the quantized MDCT coefficient of each scale factor band is data within the target quantized bit depth and obtains the quantized MDCT coefficient.

Furthermore, the bit allocation unit 54 generates Mute information indicating that the quantization result is not the Mute data, for the object to be processed, and holds the Mute information.

In step S45, the bit allocation unit 54 determines whether or not the time is within the predetermined time limit for the actual time processing.

For example, in a case where a predetermined time has elapsed from start of the bit allocation processing, it is determined that the time is not within the time limit.

This time limit is a threshold set (determined) by the bit allocation unit 54 in consideration of a processing time necessary for the encoding unit 55 and the packing unit 23 in the subsequent stage of the bit allocation unit 54, for example, so that the encoded bit stream can be output (distributed) in real time, that is, the encoding processing can be executed as the actual time processing.

Furthermore, this time limit may be dynamically changed, on the basis of the processing result of previous bit allocation processing, such as the value of the quantized MDCT coefficient of the object obtained through the previous processing of the bit allocation unit 54.

In a case where it is determined in step S45 that the time is within the time limit, thereafter, the processing proceeds to step S46.

In step S46, the bit allocation unit 54 saves (holds) the quantized MDCT coefficient obtained by the processing in step S44 as the quantization result of the object to be processed and adds “1” to the value of the processing target ID. As a result, a new object on which the minimum quantization processing is not executed yet is set as a new object to be processed.

If the processing in step S46 is executed, thereafter, the processing returns to step S43, and the above processing is repeated. That is, the minimum quantization processing is executed on the new object to be processed.

In this way, in steps S43 to S46, the minimum quantization processing is executed on each object, in descending order of the priority. As a result, the encoding efficiency can be improved.

Furthermore, in a case where it is determined in step S45 that the time is not within the time limit, that is, in a case where the time limit has come, the minimum quantization processing for each object is terminated, and thereafter, the processing proceeds to step S47. That is, in this case, the minimum quantization processing on an object that is not a processing target is terminated in an uncompleted state.

In step S47, the bit allocation unit 54 saves (hold) the quantized value of the Mute data prepared in advance, as the quantization result of each object, for the object that is not a processing target in steps S43 to S46 described above, that is, the object on which the minimum quantization processing is not completed.

That is, in step S47, the quantized value of the Mute data is used as the quantization result of the object, for the object on which the minimum quantization processing is not completed.

Furthermore, the bit allocation unit 54 generates and holds the Mute information indicating that the quantization result is the Mute data, for the object on which the minimum quantization processing is not completed.

If the processing in step S47 is executed, thereafter, the processing proceeds to step S54.

Furthermore, in a case where it is determined in step S43 that the value of the processing target ID is not less than N, that is, in a case where the minimum quantization processing has been completed on all the objects within the time limit, processing in step S48 is executed.

In step S48, the bit allocation unit 54 sets the processing target ID indicating the object to be processed to “0”. As a result, the objects are set as the object to be processed in descending order of the priority again, and the following processing is executed.

In step S49, the bit allocation unit 54 determines whether or not the value of the processing target ID is less than N.

In a case where it is determined in step S49 that the value of the processing target ID is less than N, that is, in a case where the additional quantization processing (additional encoding processing) is not executed on all the objects yet, processing in step S50 is executed.

In step S50, the bit allocation unit 54 executes the additional quantization processing, that is, additional bit allocation loop processing once, on the MDCT coefficient for each scale factor band of the object to be processed indicated by the processing target ID and updates and saves the quantization result as needed.

Specifically, the bit allocation unit 54 recalculates and reevaluates the quantized bit and the quantization noise of each scale factor band, on the basis of the auditory psychological parameter and the quantized MDCT coefficient that is the quantization result for each scale factor band of the object obtained through previous processing such as the minimum quantization processing. As a result, a target quantized bit depth of the quantized MDCT coefficient is newly determined for each scale factor band.

The bit allocation unit 54 quantizes the MDCT coefficient for each scale factor band again so that the quantized MDCT coefficient of each scale factor band is data within the target quantized bit depth and obtains the quantized MDCT coefficient.

Then, in a case where a high-quality quantized MDCT coefficient with less quantization noise or the like than the quantized MDCT coefficient held as the quantization result of the object is obtained through the processing in step S50, the bit allocation unit 54 replaces the holding quantized MDCT coefficient with the newly obtained quantized MDCT coefficient and saves the newly obtained quantized MDCT coefficient. That is, the held quantized MDCT coefficient is updated.

In step S51, the bit allocation unit 54 determines whether or not the time is within the predetermined time limit for the actual time processing.

For example, as in a case of step S45, in a case where a predetermined time has elapsed from the start of the bit allocation processing, it is determined in step S51 that the time is not within the time limit.

Note that the time limit in step S51 may be the same as that in a case of step S45 or may be dynamically changed according to a processing result of the previous bit allocation processing, that is, the minimum quantization processing or the additional bit allocation loop processing, as described above.

In a case where it is determined in step S51 that the time is within the time limit, since time still remains until the time limit, the processing proceeds to step S52.

In step S52, the bit allocation unit 54 determines whether or not the loop processing of the additional quantization processing, that is, the additional bit allocation loop processing ends.

For example, in step S52, it is determined that the loop processing ends, in a case where the additional bit allocation loop processing is repeated a predetermined number of times, in a case where a difference between the quantization noises in the two times of most recent bit allocation loop processing is equal to or less than a threshold, or the like.

In a case where it is determined in step S52 that the loop processing does not end yet, the processing returns to step S50, and the above processing is repeated.

On the other hand, in a case where it is determined in step S52 that the loop processing ends, processing in step S53 is executed.

In step S53, the bit allocation unit 54 saves (holds) the quantized MDCT coefficient updated in step S50 as a final quantization result of the object to be processed and adds “1” to the value of the processing target ID. As a result, a new object on which the additional quantization processing is not executed yet is set as a new object to be processed.

If the processing in step S53 is executed, thereafter, the processing returns to step S49, and the above processing is repeated. That is, the additional quantization processing is executed on the new object to be processed.

In this way, in steps S49 to S53, the additional quantization processing is executed on each object, in descending order of the priority. As a result, the encoding efficiency can be further improved.

Furthermore, in a case where it is determined in step S51 that the time is not within the time limit, that is, in a case where the time limit has come, the additional quantization processing for each object is terminated, and thereafter, the processing proceeds to step S54.

That is, in this case, for some objects, the minimum quantization processing is completed. However, the additional quantization processing is terminated in an uncompleted state. Therefore, for some objects, the result of the minimum quantization processing is output as the final quantized MDCT coefficient.

However, in steps S49 to S53, the processing is executed in descending order of the priority, the object on which the processing is terminated is an object with relatively low priority. That is, since a high-quality quantized MDCT coefficient can be obtained for an object with high priority, the deterioration in the sound quality can be minimized.

Moreover, in a case where it is determined in step S49 that the value of the processing target ID is not less than N, that is, in a case where the additional quantization processing is completed for all the objects within the time limit, the processing proceeds to step S54.

In a case where the processing in step S47 is executed, it is determined in step S49 that the value of the processing target ID is not less than N, or it is determined in step S51 that the time is not within the time limit, processing in step S54 is executed.

In step S54, the bit allocation unit 54 outputs the quantized MDCT coefficient held as the quantization result for each object, that is, the saved quantized MDCT coefficient to the encoding unit 55.

At this time, regarding the object on which the minimum quantization processing is not completed, the quantized value of the Mute data held as the quantization result is output to the encoding unit 55.

Furthermore, the bit allocation unit 54 supplies the Mute information of each object to the packing unit 23 and ends the bit allocation processing.

If the Mute information is supplied to the packing unit 23, in step S17 in FIG. 3 described above, the packing unit 23 stores the Mute information in the encoded bit stream.

The Mute information is flag information having “0” or “1” as a value, or the like.

Specifically, for example, in a case where all the quantized MDCT coefficients in the frame to be encoded of the object are zero, that is, in a case where the quantization result is the Mute data, the value of the Mute information is “1”. On the other hand, in a case where the quantization result is not the Mute data, the value of the Mute information is “0”.

Such Mute information is written, for example, in the metadata of the object, the ancillary region of the encoded bit stream, or the like. Note that the Mute information is not limited to the flag information and may have a character string of alphabets or other symbols such as “MUTE”.

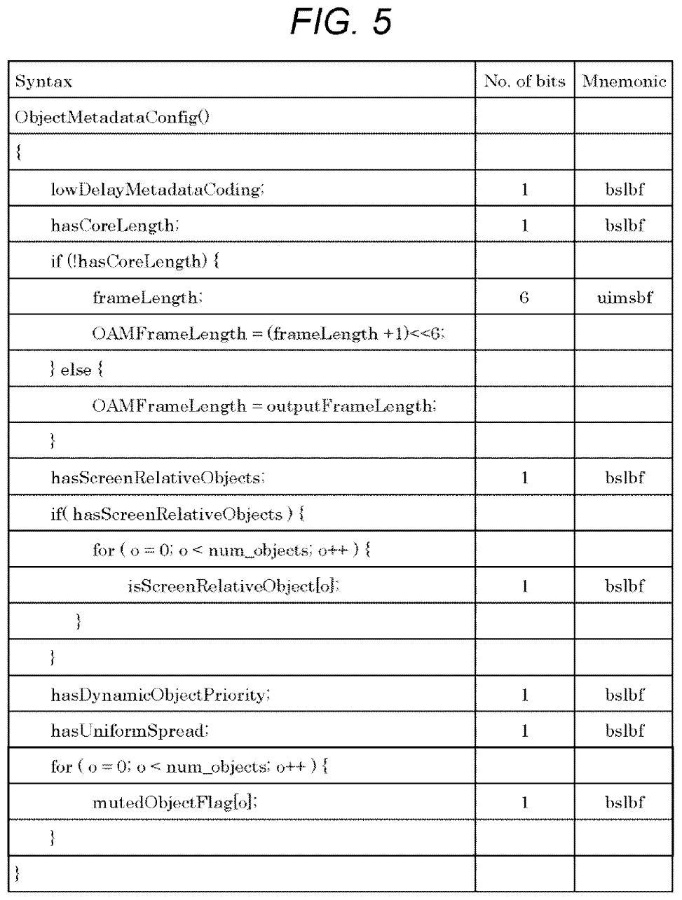

As an example, a syntax example in which the Mute information is added to ObjectMetadataConfig( ) of MPEG-H is illustrated in FIG. 5.

In the example in FIG. 5, Mute information “mutedObjectFlag [o]” is stored by the number of objects (num_objects) in Config of the metadata.

As described above, in a case where all the quantized MDCT coefficients of the object are “0”, “1” is set as the Mute information (mutedObjectFlag[o]), and in other cases, “0” is set.

By writing such Mute information, on the decoding side, 0 data (zero data) can be used as an IMDCT output, instead of performing inverse modified discrete cosine transform (IMDCT), on the object having the Mute information of “1”. As a result, the decoding processing can be accelerated.

As described above, the bit allocation unit 54 executes the minimum quantization processing and the additional quantization processing in order from the object with higher priority.

In this way, it is possible to complete the additional quantization processing (additional bit allocation loop processing) for the object with higher priority, and it is possible to improve the encoding efficiency of the entire content in the actual time processing. As a result, more object data can be transmitted.

Note that, a case has been described above where the priority information is input to the bit allocation unit 54 and the time-frequency transform unit 52 performs time-frequency transform on all the objects. However, for example, the priority information may be supplied to the time-frequency transform unit 52.

In such a case, the time-frequency transform unit 52 does not perform time-frequency transform on an object with low priority indicated by the priority information, replaces all the MDCT coefficients of each scale factor band to the 0 data (zero data) and supplies the zero data to the bit allocation unit 54.

As a result, as compared with a case of the configuration illustrated in FIG. 2, a processing time and a processing amount of the object with low priority can be further reduced, and a more processing time can be secured for the object with high priority.

### <Configuration Example of Decoder>

Subsequently, a decoder that receives (acquires) the encoded bit stream output from the encoder 11 illustrated in FIG. 1 and decodes the encoded metadata and the encoded audio signal will be described.

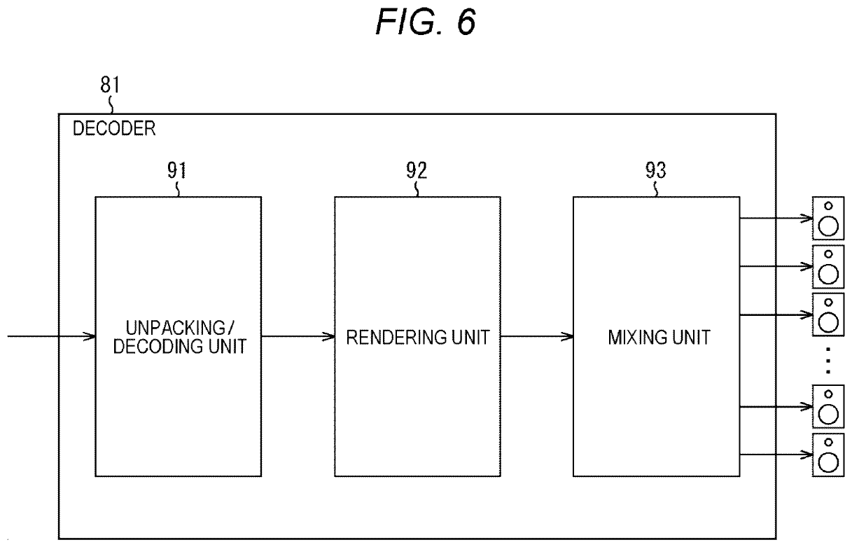

Such a decoder is configured as illustrated in FIG. 6, for example.

A decoder 81 illustrated in FIG. 6 includes an unpacking/decoding unit 91, a rendering unit 92, and a mixing unit 93.

The unpacking/decoding unit 91 acquires the encoded bit stream output from the encoder 11 and unpacks and decodes the encoded bit stream.

The unpacking/decoding unit 91 supplies an audio signal of each object obtained by unpacking and decoding and metadata of each object to the rendering unit 92. At this time, the unpacking/decoding unit 91 decodes the encoded audio signal of each object according to the Mute information included in the encoded bit stream.

The rendering unit 92 generates audio signals of M channels on the basis of the audio signal of each object supplied from the unpacking/decoding unit 91 and the object position information included in the metadata of each object and supplies the generated audio signal to the mixing unit 93. At this time, the rendering unit 92 generates the audio signal of each of the M channels so as to locate a sound image of each at a position indicated by the object position information of the object.

The mixing unit 93 supplies the audio signal of each channel supplied from the rendering unit 92 to a speaker corresponding to each external channel and reproduces sound.

Note that, in a case where the encoded audio signal for each channel is included in the encoded bit stream, the mixing unit 93 performs weighted addition for each channel, on the audio signal of each channel supplied from the unpacking/decoding unit 91 and the audio signal of each channel supplied from the rendering unit 92 and generates a final audio signal of each channel.

### <Configuration Example of Unpacking/Decoding Unit>

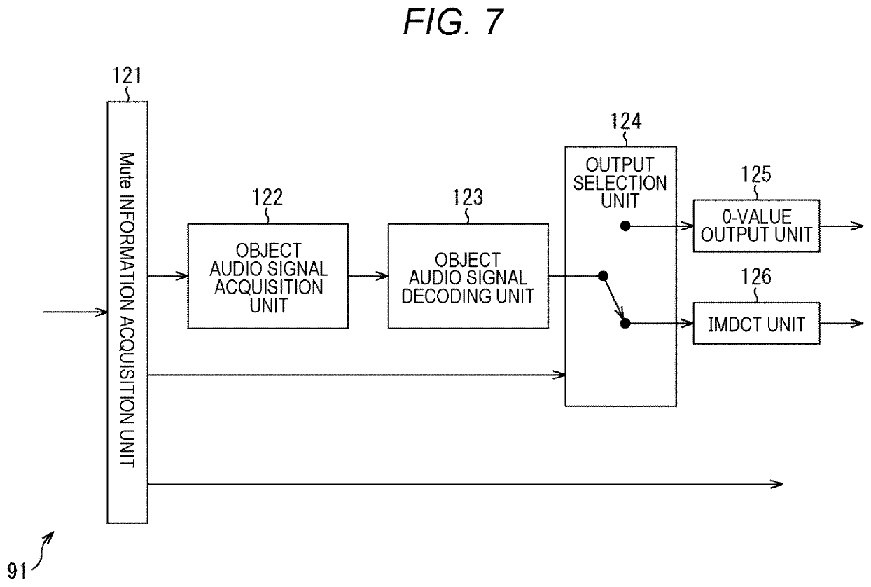

Furthermore, more specifically, the unpacking/decoding unit 91 of the decoder 81 illustrated in FIG. 6 is configured as illustrated in FIG. 7, for example.

The unpacking/decoding unit 91 illustrated in FIG. 7 includes a Mute information acquisition unit 121, an object audio signal acquisition unit 122, an object audio signal decoding unit 123, an output selection unit 124, a 0-value output unit 125, and an IMDCT unit 126.

The Mute information acquisition unit 121 acquires the Mute information of the audio signal of each object from the supplied encoded bit stream and supplies the Mute information to the output selection unit 124.

Furthermore, the Mute information acquisition unit 121 acquires the encoded metadata of each object from the supplied encoded bit stream and decodes the encoded metadata, and supplies metadata obtained as a result to the rendering unit 92. Moreover, the Mute information acquisition unit 121 supplies the supplied encoded bit stream to the object audio signal acquisition unit 122.

The object audio signal acquisition unit 122 acquires the encoded audio signal of each object from the encoded bit stream supplied from the Mute information acquisition unit 121 and supplies the encoded audio signal to the object audio signal decoding unit 123.

The object audio signal decoding unit 123 decodes the encoded audio signal of each object supplied from the object audio signal acquisition unit 122 and supplies the MDCT coefficient obtained as a result, to the output selection unit 124.

The output selection unit 124 selectively switches an output destination of the MDCT coefficient of each object supplied from the object audio signal decoding unit 123, on the basis of the Mute information of each object supplied from the Mute information acquisition unit 121.

Specifically, in a case where a value of the Mute information about a predetermined object is “1”, that is, in a case where the quantization result is the Mute data, the output selection unit 124 sets the MDCT coefficient of the object to zero and supplies zero to the 0-value output unit 125. That is, the zero data is supplied to the 0-value output unit 125.

On the other hand, in a case where the value of the Mute information about the predetermined object is “0”, that is, in a case where the quantization result is not the Mute data, the output selection unit 124 supplies the MDCT coefficient of the object supplied from the object audio signal decoding unit 123, to the IMDCT unit 126.

The 0-value output unit 125 generates an audio signal on the basis of the MDCT coefficient (zero data) supplied from the output selection unit 124 and supplies the audio signal to the rendering unit 92. In this case, since the MDCT coefficient is zero, a silent audio signal is generated.

The IMDCT unit 126 performs the IMDCT on the basis of the MDCT coefficient supplied from the output selection unit 124, generates an audio signal, and supplies the audio signal to the rendering unit 92.

### <Description of Decoding Processing>

Next, an operation of the decoder 81 will be described.

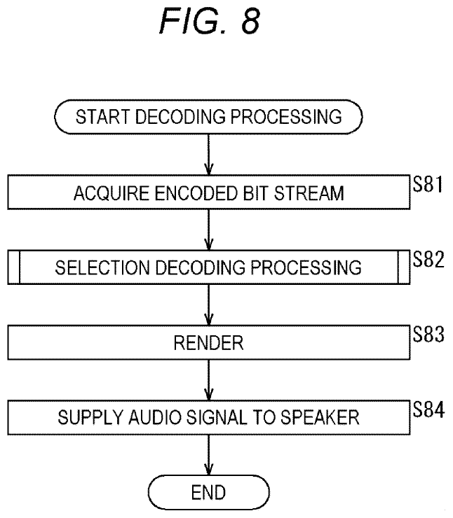

If an encoded bit stream for one frame is supplied from the encoder 11, the decoder 81 executes the decoding processing so as to generate an audio signal, and outputs the audio signal to the speaker. Hereinafter, the decoding processing executed by the decoder 81 will be described with reference to the flowchart in FIG. 8.

In step S81, the unpacking/decoding unit 91 acquires (receives) the encoded bit stream transmitted from the encoder 11.

In step S82, the unpacking/decoding unit 91 executes selection decoding processing.

Note that details of the selection decoding processing will be described later. In the selection decoding processing, the encoded audio signal of each object is selectively decoded on the basis of the Mute information. Then, the audio signal of each object obtained as a result is supplied to the rendering unit 92. Furthermore, the metadata of each object acquired from the encoded bit stream is supplied to the rendering unit 92.

In step S83, the rendering unit 92 renders the audio signal of each object, on the basis of the audio signal of each object supplied from the unpacking/decoding unit 91 and the object position information included in the metadata of each object.

For example, the rendering unit 92 generates an audio signal of each channel so that the sound image of each object is located at the position indicated by the object position information, through vector base amplitude panning (VBAP) on the basis of the object position information, and supplies the audio signal to the mixing unit 93. Note that a rendering method is not limited to the VBAP, and other methods may be used. Furthermore, as described above, the position information of the object includes, for example, the horizontal angle (Azimuth), the vertical angle (Elevation), and the distance (Radius), and may be represented, for example, by orthogonal coordinates (X, Y, Z).

In step S84, the mixing unit 93 supplies the audio signal of each channel supplied from the rendering unit 92 to the speaker corresponding to the channel and reproduces sound. If the audio signal of each channel is supplied to the speaker, the decoding processing ends.

As described above, the decoder 81 acquires the Mute information from the encoded bit stream and decodes the encoded audio signal of each object according to the Mute information.

### <Description of Selection Decoding Processing>

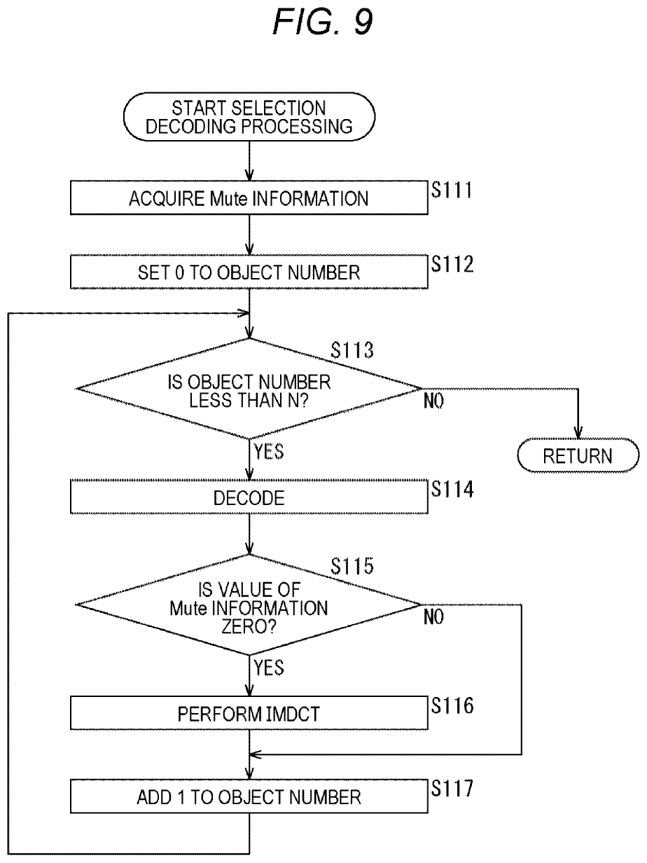

Subsequently, the selection decoding processing corresponding to the processing in step S82 in FIG. 8 will be described with reference to the flowchart in FIG. 9.

In step S111, the Mute information acquisition unit 121 acquires the Mute information of the audio signal of each object from the supplied encoded bit stream and supplies the Mute information to the output selection unit 124.

Furthermore, the Mute information acquisition unit 121 acquires the encoded metadata of each object from the encoded bit stream and decodes the encoded metadata, and supplies metadata obtained as a result to the rendering unit 92 and supplies the encoded bit stream to the object audio signal acquisition unit 122.

In step S112, the object audio signal acquisition unit 122 sets zero to the object number of the object to be processed and holds the object number.

In step S113, the object audio signal acquisition unit 122 determines whether or not the held object number is less than the number of objects N.

In a case where it is determined in step S113 that the object number is less than N, in step S114, the object audio signal decoding unit 123 decodes the encoded audio signal of the object to be processed.

That is, the object audio signal acquisition unit 122 acquires the encoded audio signal of the object to be processed, from the encoded bit stream supplied from the Mute information acquisition unit 121 and supplies the encoded audio signal to the object audio signal decoding unit 123.

Then, the object audio signal decoding unit 123 decodes the encoded audio signal supplied from the object audio signal acquisition unit 122 and supplies the MDCT coefficient obtained as a result, to the output selection unit 124.

In step S115, the output selection unit 124 determines whether or not the value of the Mute information of the object to be processed supplied from the Mute information acquisition unit 121 is “0”.

In a case where it is determined in step S115 that the value of the Mute information is “0”, the output selection unit 124 supplies the MDCT coefficient of the object to be processed, supplied from the object audio signal decoding unit 123, to the IMDCT unit 126, and the processing proceeds to step S116.

In step S116, the IMDCT unit 126 performs the IMDCT on the basis of the MDCT coefficient supplied from the output selection unit 124, generates the audio signal of the object to be processed, and supplies the audio signal to the rendering unit 92. If the audio signal is generated, thereafter, the processing proceeds to step S117.

On the other hand, in a case where it is determined in step S115 that the value of the Mute information is not “O”, that is, the value of the Mute information is “1”, the output selection unit 124 sets the MDCT coefficient to zero and supplies zero to the 0-value output unit 125.

The 0-value output unit 125 generates an audio signal of the object to be processed from the MDCT coefficient which is zero supplied from the output selection unit 124 and supplies the audio signal to the rendering unit 92. Therefore, the 0-value output unit 125 does not substantially execute any processing to generate the audio signal, such as the IMDCT.

Note that the audio signal generated by the 0-value output unit 125 is a silent signal. If the audio signal is generated, thereafter, the processing proceeds to step S117.

If it is determined in step S115 that the value of the Mute information is not “0” or when the audio signal is generated in step S116, in step S117, the object audio signal acquisition unit 122 adds one to the held object number and updates the object number of the object to be processed.

If the object number is updated, thereafter, the processing returns to step S113, and the above processing is repeated. That is, an audio signal of a new object to be processed is generated.

Furthermore, in a case where it is determined in step S113 that the object number of the object to be processed is not less than N, the selection decoding processing ends because the audio signals for all the objects are obtained, and thereafter, the processing proceeds to step S83 in FIG. 8.

As described above, the decoder 81 decodes the encoded audio signal while determining whether or not to decode the encoded audio signal for each object of the frame to be processed, on the basis of the Mute information, for each object.

That is, the decoder 81 decodes only necessary encoded audio signal, according to the Mute information of each audio signal. As a result, while the deterioration of the sound quality of the sound reproduced according to the audio signal is minimized, it is possible not only to reduce a calculation amount of decoding but also to reduce a calculation amount of subsequent processing such as the processing of the rendering unit 92 or the like.

### Second Embodiment

### <Configuration Example of Object Audio Encoding Unit>

Furthermore, the first embodiment described above is an example in which fixed-viewpoint 3DAudio content (audio signal) is distributed. In this case, a user's listening position is a fixed position.

However, in MPEG-I free viewpoint 3DAudio, the user's listening position is not the fixed position, and a user can move to any position. Therefore, a priority of each object changes according to a relationship (positional relationship) between the user's listening position and a position of the object.

Therefore, in a case where content (audio signal) to be distributed is free viewpoint 3DAudio content, priority information may be generated in consideration of an audio signal of an object, a Priority value of metadata, object position information, and listening position information indicating a user's listening position.

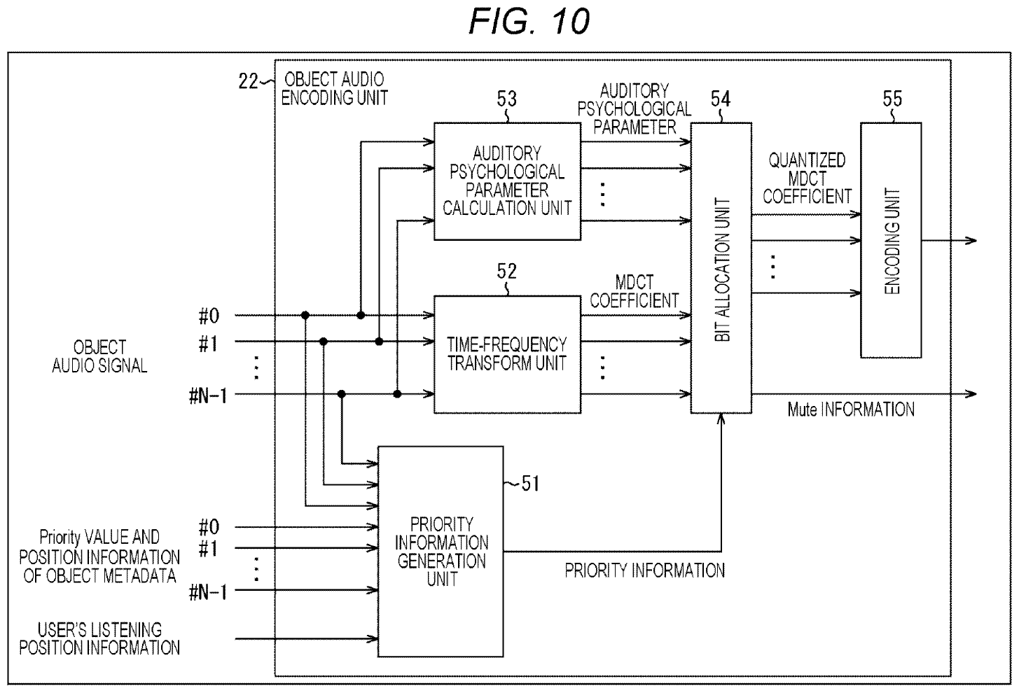

In such a case, an object audio encoding unit 22 of an encoder 11 is configured as illustrated in FIG. 10, for example. Note that, in FIG. 10, portions corresponding to those in a case of FIG. 2 are denoted by the same reference numerals, and description thereof will be appropriately omitted.

The object audio encoding unit 22 illustrated in FIG. 10 includes a priority information generation unit 51, a time-frequency transform unit 52, an auditory psychological parameter calculation unit 53, a bit allocation unit 54, and an encoding unit 55.

A configuration of the object audio encoding unit 22 in FIG. 10 is basically the same as the configuration illustrated in FIG. 2. However, the configuration is different from the example illustrated in FIG. 2 in that the object position information and the listening position information are supplied to the priority information generation unit 51, in addition to the Priority value.

That is, in the example in FIG. 10, to the priority information generation unit 51, the audio signal of each object, the Priority value and the object position information included in the metadata of each object, and the listening position information indicating the user's listening position in the three-dimensional space are supplied.

For example, the listening position information is received (acquired) by the encoder 11 from a decoder 81 that is a content distribution destination.

Furthermore, here, since the content is the free viewpoint 3DAudio content, the object position information included in the metadata is, for example, coordinate information indicating a sound source position in the three-dimensional space, that is, an absolute position of the object, or the like. Note that the object position information is not limited to this and may be coordinate information indicating a relative position of the object.

The priority information generation unit 51 generates the priority information on the basis of at least any one of the audio signal of each object, the Priority value of each object, or the object position information and the listening position information (metadata and listening position information) of each object and supplies the priority information to the bit allocation unit 54.

For example, as compared with a case where a distance between the object and a user (listener) is short, a volume of the object is lowered as the distance between the object and the listener becomes longer, and the priority of the object tends to decrease.

Therefore, for example, by adjusting a priority using a lower-order nonlinear function with which the priority is lowered as the distance between the object and the user's listening position becomes longer, for the priority obtained by the priority information generation unit 51 on the basis of the audio signal and the Priority value of the object, priority information indicating the adjusted priority may be set as final priority information. In this way, the priority information more suitable for subjectivity can be obtained.

Even in a case where the object audio encoding unit 22 has the configuration illustrated in FIG. 10, the encoder 11 executes encoding processing described with reference to FIG. 3.

However, in step S12, the priority information is generated by using the object position information and the listening position information as necessary. That is, the priority information is generated on the basis of at least any one of the audio signal, the Priority value, or the object position information and the listening position information.

### Third Embodiment

### <Configuration Example of Content Distribution System>

By the way, even if limitation processing for actual time processing for improving an encoding efficiency as in the first embodiment is executed in live streams of a live or a concert, a processing load may be rapidly increased due to interruption of an operating system (OS) or the like in hardware that implements an encoder. In such a case, it is considered that the number of objects, of which processing is not completed within a time limit of the actual time processing, is increased, and auditory uncomfortable feeling is given. That is, a sound quality may be deteriorated.

Therefore, in order to prevent occurrence of such auditory uncomfortable feeling, that is, deterioration in a sound quality, a plurality pf pieces of input data having different numbers of objects is prepared by pre-rendering, and each input data may be encoded (encoded) by different hardware.

In this case, for example, an encoded bit stream with the largest number of objects, among encoded bit streams in which the limitation processing for the actual time processing has not occurred is output to a decoder 81. Therefore, even in a case where hardware of which the processing load is rapidly increased due to the interruption of the OS or the like is included in the plurality of pieces of hardware, the occurrence of the auditory uncomfortable feeling can be prevented.

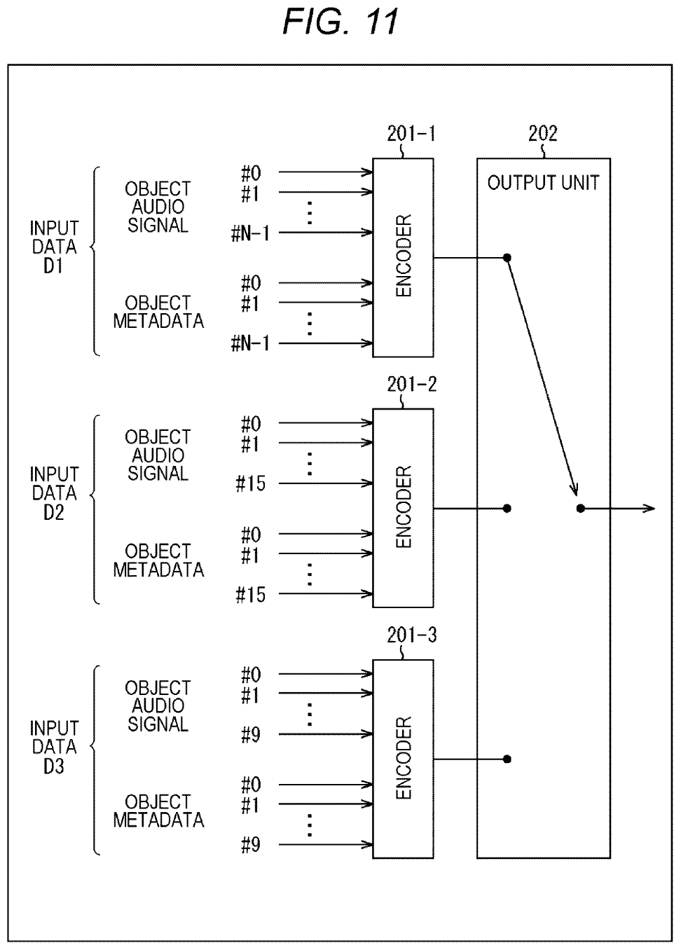

As described above, in a case where the plurality of pieces of input data is prepared in advance, a content distribution system that distributes content is configured as illustrated in FIG. 11, for example.

The content distribution system illustrated in FIG. 11 includes encoders 201-1 to 201-3 and an output unit 202.

For example, in the content distribution system, three pieces of input data D1 to D3 having different numbers of objects from each other are prepared, as data used to reproduce the same content.

Here, the input data D1 is data including audio signals and metadata of N objects, and for example, the input data D1 is original data on which pre-rendering is not performed, or the like.

Furthermore, the input data D2 is data including audio signals and metadata of 16 objects, less than the input data D1, and for example, the input data D2 is data obtained by performing pre-rendering on the input data D1, or the like.

Similarly, the input data D3 is data including audio signals and metadata of 10 objects, less than the input data D2, and for example, the input data D3 is data obtained by performing pre-rendering on the input data D1, or the like.

Even if content (audio) is reproduced by any one of such input data D1 to the input data D3, the same sound is basically reproduced.

In the content distribution system, the input data D1 is supplied (input) to the encoder 201-1, the input data D2 is supplied to the encoder 201-2, and the input data D3 is supplied to the encoder 201-3.

The encoders 201-1 to 201-3 are implemented by hardware such as computers different from each other. In other words, the encoders 201-1 to 201-3 are implemented by OSs different from each other.

The encoder 201-1 generates an encoded bit stream by executing encoding processing on the supplied input data D1 and supplies the encoded bit stream to the output unit 202.

Similarly, the encoder 201-2 generates an encoded bit stream by executing the encoding processing on the supplied input data D2 and supplies the encoded bit stream to the output unit 202, and the encoder 201-3 generates an encoded bit stream by executing the encoding processing on the supplied input data D3 and supplies the encoded bit stream to the output unit 202.

Note that, hereinafter, in a case where it is not necessary to particularly distinguish the encoders 201-1 to 201-3 from each other, the encoders 201-1 to 201-3 are also simply referred to as an encoder 201.

Each encoder 201 has the configuration same as that of the encoder 11 illustrated in FIG. 1, for example. Each encoder 11 generates the encoded bit stream by executing the encoding processing described with reference to FIG. 3.

Furthermore, here, an example will be described in which the three encoders 201 are provided in the content distribution system. However, the number of encoders 201 is not limited to this, and two or four or more encoders 201 may be provided.

The output unit 202 selects one of the encoded bit streams respectively supplied from the plurality of encoders 201 and transmits the selected encoded bit stream to the decoder 81.

For example, the output unit 202 specifies whether or not the plurality of encoded bit streams includes an encoded bit stream that does not include Mute information with a value of “1”, that is, an encoded bit stream of which a value of Mute information of all objects is “0”.

Then, in a case where there is the encoded bit stream that does not include the Mute information with the value of “1”, the output unit 202 selects an encoded bit stream with the largest number of objects, from among the encoded bit streams that do not include the Mute information with the value of “1” and transmits the encoded bit stream to the decoder 81.

Furthermore, in a case where there is no encoded bit stream that does not include the Mute information with the value of “1”, for example, the output unit 202 selects an encoded bit stream with the largest number of objects, an encoded bit stream with the largest number of objects of which the Mute information is “0”, or the like and transmits the encoded bit stream to the decoder 81.

As described above, by selecting one of the plurality of encoded bit streams and outputting the encoded bit stream, it is possible to prevent the occurrence of the auditory uncomfortable feeling and to realize high-quality audio reproduction.

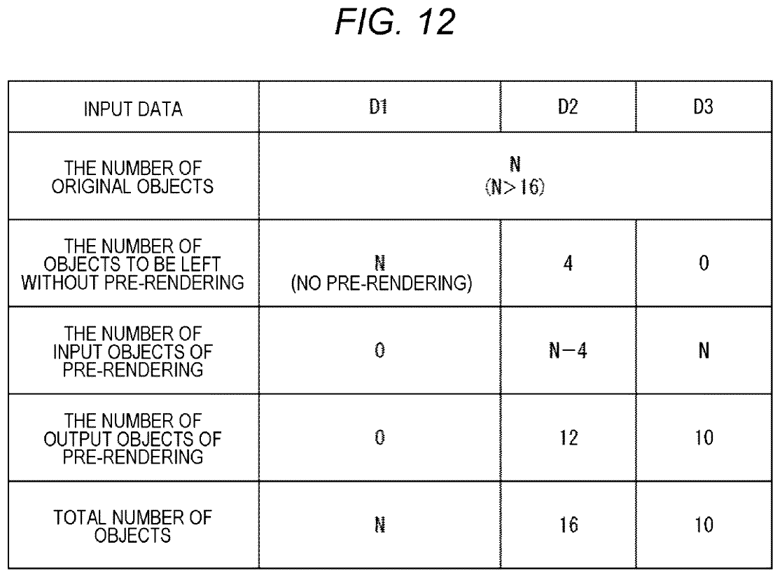

Here, with reference to FIG. 12, a specific example of the input data D1 to D3 in a case where data including metadata and audio signals of N (N>16) objects is prepared as original data of content will be described.

In this example, in any one of the input data D1 to D3, the original (original) data is the same, and the number of objects in the data is N.

In particular, the input data D1 is assumed as the original data itself.

Therefore, the input data D1 is data including the metadata and the audio signals of N original (original) objects, and metadata and an audio signal of a new object generated by pre-rendering are not included in the input data D1.

Furthermore, the input data D2 and D3 are data obtained by performing pre-rendering on the original data.

Specifically, the input data D2 is data including metadata and audio signals of four objects with high priority among the N original objects and metadata and audio signals of 12 new objects generated by pre-rendering.

The data of the 12 objects that is not original and is included in the input data D2 is generated by pre-rendering based on data of (N−4) objects, which are not included in the input data D2, among the N original objects.

Furthermore, in the input data D2, regarding the four objects, the metadata and the audio signal of the original object are not pre-rendered and included in the input data D2.

The input data D3 is data including metadata and audio signals of new 10 objects generated by pre-rendering, in which the data of the original object is not included.

The metadata and the audio signals of the 10 objects are generated by pre-rendering based on the data of the N original objects.

As described above, by performing pre-rendering on the basis of the data of the original object and generating metadata and an audio signal of a new object, input data of which the number of objects is reduced can be prepared.

Note that, here, the original object data is only the input data D1. However, the original data may be used as a plurality of pieces of input data, on which pre-rendering is not performed, in consideration of sudden occurrence of the interruption of the OS or the like. That is, for example, not only the input data D1 but also the input data D2 may be the original data.

In this way, for example, even if the interruption of the OS or the like suddenly occurs in the encoder 201-1 using the input data D1 as input, if the interruption of the OS or the like does not occur in the encoder 201-2 using the input data D2 as input, the deterioration in the sound quality can be prevented. That is, the encoder 201-2 is likely to obtain an encoded bit stream that does not include the Mute information with the value of “1”.

In addition, for example, by performing pre-rendering based on the original object data, a large number of pieces of input data of which the number of objects is further smaller than the input data D3 illustrated in FIG. 12 may be prepared. Furthermore, the number of object signals (audio signals) and pieces of object metadata (metadata) of each of the input data D1 to D3 may be set by a user side or may be dynamically changed according to a resource of each encoder 201 or the like.

As described above, according to the present technology described in the first to third embodiments, even in a case where all the processing of the actual time processing is not completed within the time limit, an encoding efficiency of entire content can be improved by executing additional bit allocation processing for improving the encoding efficiency in descending order of importance of sound of the object.

### Fourth Embodiment

### <About Underflow>

As described above, in the 3D Audio handled compliant with the MPEG-H 3D Audio standard or the like, metadata for each object such as a horizontal angle and a vertical angle indicating a position of a sound material (object), a distance, a gain for the object, or the like is held, and a three-dimensional sound direction, distance, spread, or the like can be reproduced.

In typical stereo reproduction, a mixing engineer pans individual sound materials called mixdown to left and right channels, on the basis of multitrack data including a large number of sound materials, so as to obtain a stereo audio signal.

On the other hand, in the 3D Audio, each sound material called an object is arranged in a three-dimensional space, and positional information of these objects is described as the metadata described above. Therefore, in the 3D Audio, a large number of objects before being mixed down, more specifically, an object audio signal of the object is encoded.

However, in a case where encoding is performed in real time as in live broadcasting, a high processing capability is required for a transmission device when the large number of objects are encoded. That is, in a case where one-frame data cannot be encoded within a predetermined time, an underflow state occurs in which there is no data to be transmitted by the transmission device, and transmission processing fails.

In order to avoid such an underflow, in an encoding device requiring real-time performance, mainly regarding processing called bit allocation that needs a large number of calculation resources, bit allocation processing is controlled to complete the processing within the predetermined time.

In recent encoding devices, to follow the advance in technology and to reduce costs, in many cases, an operating system (OS) such as Linux (registered trademark) is mounted on general-purpose hardware such as a personal computer, not an encoding device using dedicated hardware, and encoding software is operated thereon.

However, in the OS such as Linux (registered trademark), a large number of system processes other than encoding are executed in parallel, and the system processes are executed as processes with high priority. Therefore, the system process is often executed prior to the processing of the encoding software. In such a case, in the worst case, processing at the time of encoding does not reach the bit allocation processing and an underflow may occur.

In order to avoid such an underflow, in a case where there is no processing data to be output, a method for encoding and transmitting silent data (Mute data) is often adopted.

For encoding standards such as MPEG-D USAC or MPEG-H 3D Audio, a context-based arithmetic coding technology is used.

In this context-based arithmetic coding technology, quantized MDCT coefficients of a previous frame and a frame are used as context, an appearance frequency table of the quantized MDCT coefficient to be encoded is automatically selected on the basis of the context, and arithmetic coding is performed.

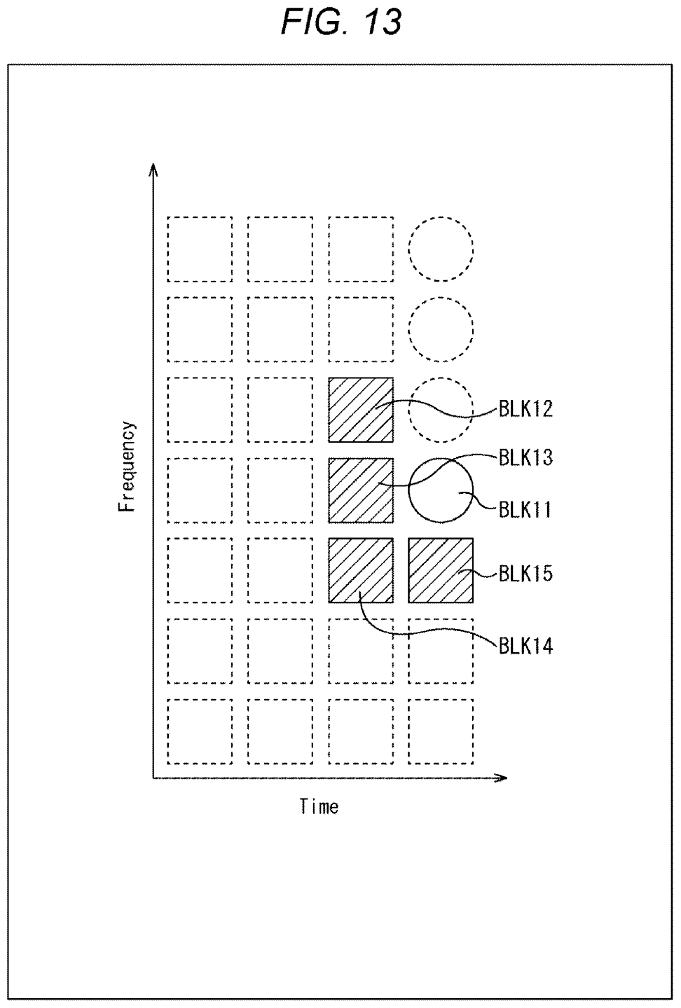

Here, a context calculation method in the context-based arithmetic coding will be described with reference to FIG. 13.

Note that, in FIG. 13, the vertical direction indicates a frequency, and the horizontal direction indicates a time, that is, a frame of an object audio signal.

Furthermore, each rectangle or circle represents an MDCT coefficient block of each frequency for each frame, each MDCT coefficient block includes two MDCT coefficients (quantized MDCT coefficient). In particular, each rectangle represents an encoded MDCT coefficient block, and each circle represents an unencoded MDCT coefficient block.

In this example, an MDCT coefficient block BLK11 is an encoding target. At this time, four MDCT coefficient blocks BLK12 to BLK15 adjacent to the MDCT coefficient block BLK11 are set as context.

In particular, the MDCT coefficient blocks BLK12 to BLK14 are MDCT coefficient blocks of a frequency same as or adjacent to the frequency of the MDCT coefficient block BLK11, in a frame temporally immediately before the frame of the MDCT coefficient block BLK11 to be encoded.

Furthermore, the MDCT coefficient block BLK15 is an MDCT coefficient block of a frequency adjacent to the frequency of the MDCT coefficient block BLK11, in the frame of the MDCT coefficient block BLK11 to be encoded.

A context value is calculated on the basis of the MDCT coefficient blocks BLK12 to BLK15, and the appearance frequency table (arithmetic encoding frequency table) used to encode the MDCT coefficient block BLK11 to be encoded is selected, on the basis of the context value.

At the time of decoding, it is necessary to perform variable-length decoding using the appearance frequency table same as that at the time of encoding, from an arithmetic code, that is, the encoded quantized MDCT coefficient. Therefore, as the calculation of the context value, it is necessary to perform completely the same calculation at the time of encoding and at the time of decoding.

Note that, since more detailed content of the context-based arithmetic coding is not directly related to the present technology, the description thereof is omitted here.

By the way, with the method for encoding and transmitting silent data (Mute data) described above, calculation for encoding the silent data is needed. Therefore, as a result, there is a case where one-frame data cannot be output within the predetermined time.

Therefore, according to the present technology, even in a case of the MPEG-H using the context-based arithmetic coding technology as the encoding method in the software-based encoding device using the OS such as Linux (registered trademark), the occurrence of the underflow can be prevented.

In particular, according to the present technology, for example, even in a case where the encoding processing is not completed due to other processing loads generated in the OS, the occurrence of the underflow can be prevented by transmitting the encoded Mute data prepared in advance.

### <Configuration Example of Encoder>

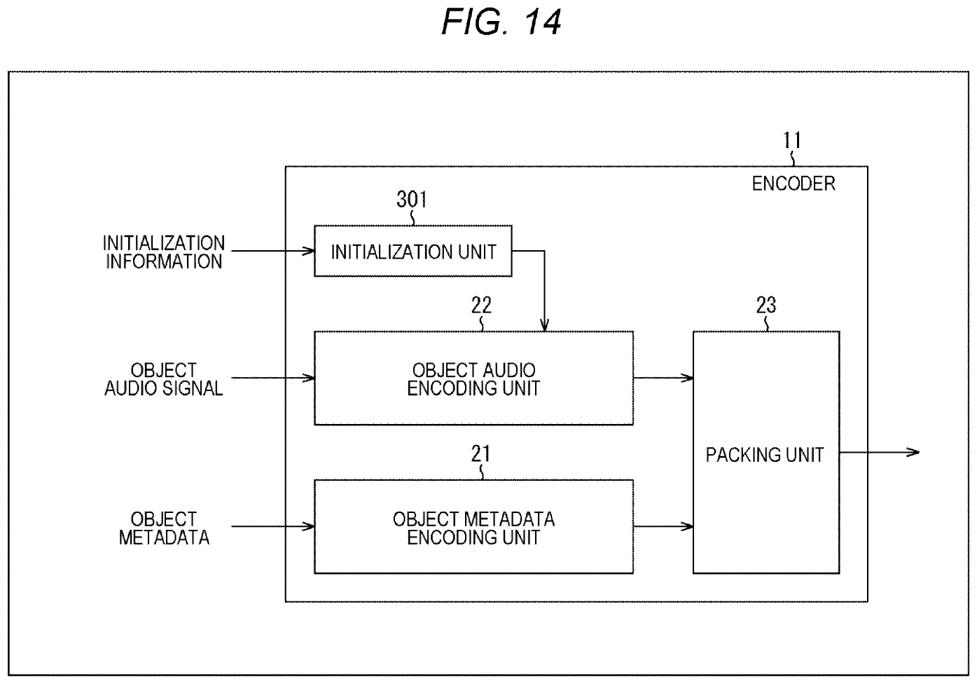

FIG. 14 is a diagram illustrating a configuration example of another embodiment of the encoder to which the present technology is applied. Note that, in FIG. 14, portions corresponding to those in a case of FIG. 1 are denoted by the same reference numerals, and description thereof will be omitted as appropriate.

An encoder 11 illustrated in FIG. 14 is, for example, a software-based encoding device using an OS or the like. That is, for example, the encoder 11 is implemented by operating encoding software by the OS in an information processing device such as a PC.

The encoder 11 includes an initialization unit 301, an object metadata encoding unit 21, an object audio encoding unit 22, and a packing unit 23.

The initialization unit 301 performs initialization performed at the time of activation or the like of the encoder 11, on the basis of initialization information supplied from the OS or the like, generates the encoded Mute data on the basis of the initialization information, and supplies the encoded Mute data to the object audio encoding unit 22.

The encoded Mute data is data obtained by encoding a quantized value of the Mute data, that is, a quantized MDCT coefficient with an MDCT coefficient “0”. It can be said that such encoded Mute data is a quantized value of an MDCT coefficient of the silent data, that is, encoded silent data obtained by encoding a quantized value of an MDCT coefficient of a silent audio signal. Note that, hereinafter, description will be made as assuming that the context-based arithmetic coding is performed as encoding. However, encoding is not limited to this, and encoding may be performed by other encoding methods.

The object audio encoding unit 22 encodes the supplied audio signal of each object (hereinafter, also referred to as object audio signal) compliant with the MPEG-H standard, and supplies an encoded audio signal obtained as a result, to the packing unit 23. At this time, the object audio encoding unit 22 appropriately uses the encoded Mute data that is supplied from the initialization unit 301 as the encoded audio signal.

Note that, as in the embodiments described above, the object audio encoding unit 22 may calculate the priority information on the basis of the metadata of each object and, for example, quantize the MDCT coefficient using the priority information.

### <Configuration Example of Object Audio Encoding Unit>

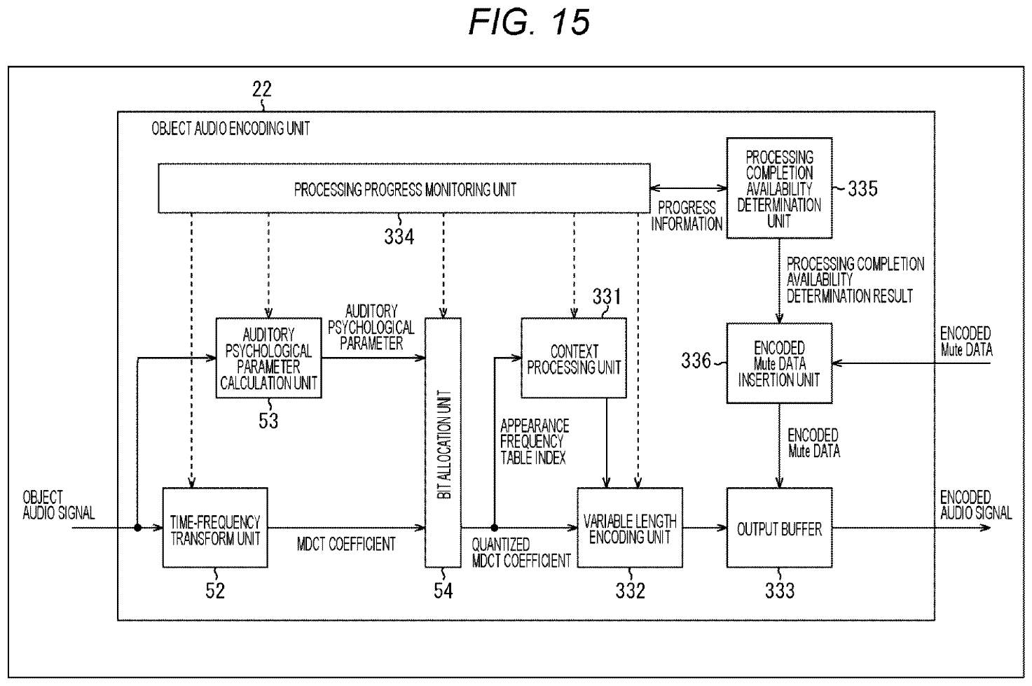

Furthermore, the object audio encoding unit 22 of the encoder 11 illustrated in FIG. 14 is configured as illustrated in FIG. 15, for example. Note that, in FIG. 15, portions corresponding to those in a case of FIG. 2 are denoted by the same reference numerals, and description thereof will be omitted as appropriate.

In the example in FIG. 15, the object audio encoding unit 22 includes a time-frequency transform unit 52, an auditory psychological parameter calculation unit 53, a bit allocation unit 54, a context processing unit 331, a variable length encoding unit 332, an output buffer 333, a processing progress monitoring unit 334, a processing completion availability determination unit 335, and an encoded Mute data insertion unit 336.

The bit allocation unit 54 executes the bit allocation processing on the basis of an MDCT coefficient supplied from the time-frequency transform unit 52 and an auditory psychological parameter supplied from the auditory psychological parameter calculation unit 53. Note that, as in the embodiments described above, the bit allocation unit 54 may execute the bit allocation processing on the basis of the priority information.

The bit allocation unit 54 supplies a quantized MDCT coefficient for each scale factor band of each object obtained by the bit allocation processing, to the context processing unit 331 and the variable length encoding unit 332.

The context processing unit 331 determines (selects) an appearance frequency table required to encode the quantized MDCT coefficient, on the basis of a quantized MDCT coefficient supplied from the bit allocation unit 54.

For example, as described with reference to FIG. 13, the context processing unit 331 determines an appearance frequency table used to encode the focused quantized MDCT coefficient, from a representative value of the plurality of quantized MDCT coefficients in the vicinity of the focused quantized MDCT coefficient (MDCT coefficient block).

The context processing unit 331 supplies an index (hereinafter, also referred to as appearance frequency table index) indicating the appearance frequency table of each quantized MDCT coefficient, determined for each quantized MDCT coefficient, more specifically, for each MDCT coefficient block, to the variable length encoding unit 332.

The variable length encoding unit 332 refers to the appearance frequency table indicated by the appearance frequency table index supplied from the context processing unit 331, variable-length encodes the quantized MDCT coefficient supplied from the bit allocation unit 54, and performs lossless compression.

Specifically, the variable length encoding unit 332 generates the encoded audio signal, by performing context-based arithmetic coding as the variable-length encoding.

Note that, in encoding standards indicated in Non-Patent Documents 1 to 3 described above, arithmetic coding is used as variable-length encoding technology. To the present technology, it is possible to apply other variable length encoding technologies, for example, a Huffman coding technology or the like, other than the arithmetic coding technology.

The variable length encoding unit 332 supplies the encoded audio signal obtained by performing variable length encoding to the output buffer 333 and makes the output buffer 333 hold the encoded audio signal.

The context processing unit 331 and the variable length encoding unit 332 that encode the quantized MDCT coefficient correspond to the encoding unit 55 of the object audio encoding unit 22 illustrated in FIG. 2.

The output buffer 333 holds a bit stream including the encoded audio signal for each frame supplied from the variable length encoding unit 332 and supplies the holding encoded audio signal (bit stream) to the packing unit 23 at an appropriate timing.

The processing progress monitoring unit 334 monitors progress of each processing executed by the time-frequency transform unit 52 to the bit allocation unit 54, the context processing unit 331, and the variable length encoding unit 332 and supplies progress information indicating a monitoring result to the processing completion availability determination unit 335.

The processing progress monitoring unit 334 appropriately instructs the time-frequency transform unit 52 to the bit allocation unit 54, the context processing unit 331, and the variable length encoding unit 332, for example, to terminate the executing processing, according to a determination result supplied from the processing completion availability determination unit 335.

The processing completion availability determination unit 335 performs processing completion availability determination for determining whether or not the processing for encoding the object audio signal is completed within a predetermined time, on the basis of the progress information supplied from the processing progress monitoring unit 334 and supplies the determination result to the processing progress monitoring unit 334 and the encoded Mute data insertion unit 336. Note that, more specifically, the determination result is supplied to the encoded Mute data insertion unit 336, only in a case where it is determined that the processing is not completed within the predetermined time.

The encoded Mute data insertion unit 336 inserts the encoded Mute data that has been prepared (generated) in advance into the bit stream including the encoded audio signal of each frame in the output buffer 333, according to the determination result supplied from the processing completion availability determination unit 335.

In this case, the encoded Mute data is inserted into the bit stream as the encoded audio signal of the frame for which it is determined that the processing is not completed within the predetermined time.

That is, in a case where it is determined that the processing is not completed within a time in a predetermined frame, the bit allocation processing is terminated. Therefore, the encoded audio signal in the predetermined frame cannot be obtained. Therefore, the output buffer 333 does not hold the encoded audio signal in the predetermined frame. Therefore, the encoded Mute data that is encoded silent data obtained by encoding zero data, that is, the silent audio signal (silent signal) is inserted into the bit stream as the encoded audio signal of the predetermined frame.

For example, the encoded Mute data may be inserted for each object (object audio signal), and in a case where the bit allocation processing is terminated, the encoded audio signals of all the objects may be assumed as the encoded Mute data.

### <Configuration Example of Initialization Unit>

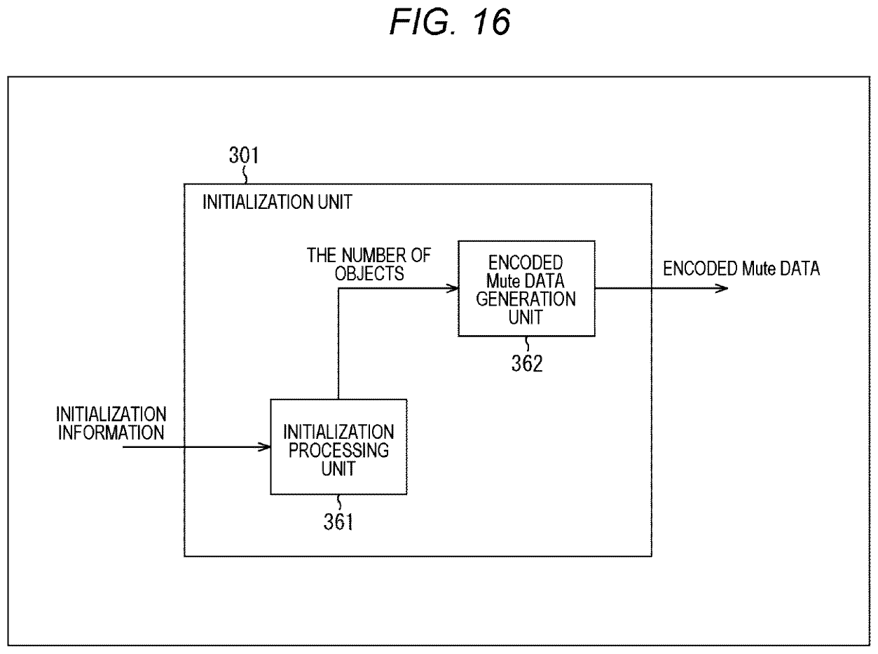

Furthermore, the initialization unit 301 of the encoder 11 illustrated in FIG. 14 is configured as illustrated in FIG. 16, for example.

The initialization unit 301 includes an initialization processing unit 361 and an encoded Mute data generation unit 362.

The initialization information is supplied to the initialization processing unit 361. For example, the initialization information includes information indicating the numbers of objects and channels included in content to be encoded, that is, the number of objects and the number of channels.

The initialization processing unit 361 performs initialization on the basis of the supplied initialization information and supplies the number of objects indicated by the initialization information, more specifically, object number information indicating the number of objects, to the encoded Mute data generation unit 362.

The encoded Mute data generation unit 362 generates the pieces of encoded Mute data as many as the number of objects indicated by the object number information supplied from the initialization processing unit 361, and supplies the encoded Mute data to the encoded Mute data insertion unit 336. That is, the encoded Mute data generation unit 362 generates the encoded Mute data for each object. Note that the encoded Mute data of each object is the same.

Furthermore, in a case where the encoder 11 encodes the audio signal of each channel, the encoded Mute data generation unit 362 generates the pieces of encoded Mute data as many as the number of channels, on the basis of channel number information indicating the number of channels.

### <About Progress of Processing and Encoded Mute Data>

Subsequently, the progress of the processing executed by each unit of the encoder 11 and the encoded Mute data will be described.

The processing progress monitoring unit 334 specifies a time by a timer supplied from a processor or an OS, and generates progress information indicating a progress degree of processing from when an object audio signal for one frame is input to a time when an encoded audio signal of the frame is generated.

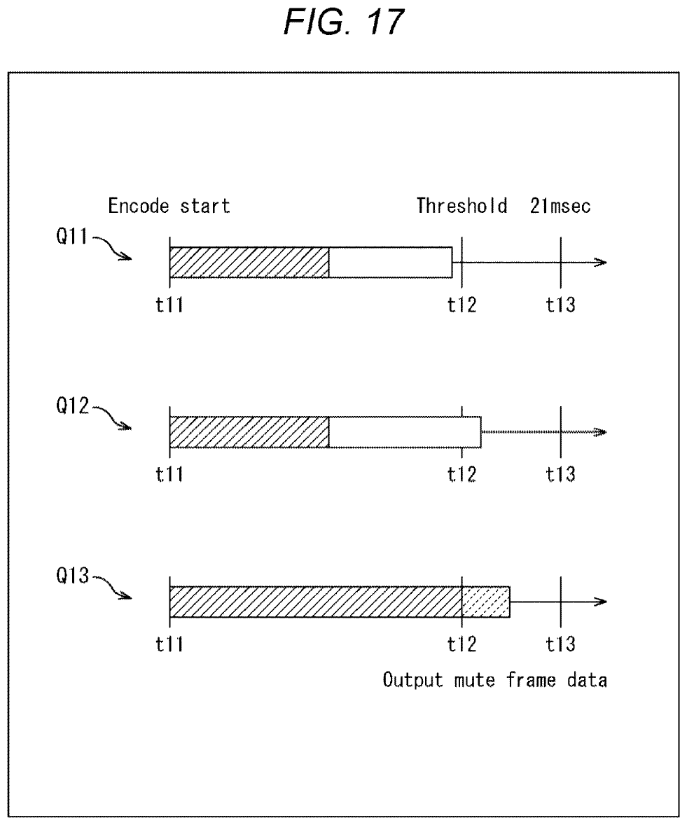

Here, a specific example of the progress information and the processing completion availability determination will be described with reference to FIG. 17. Note that, in FIG. 17, it is assumed that the object audio signal for one frame include 1024 samples.

In the example illustrated in FIG. 17, a time t11 indicates a time when an object audio signal of a frame to be processed is supplied to the time-frequency transform unit 52, that is, a time when time-frequency transform on the object audio signal to be processed is started.

Furthermore, a time t12 is a time to be a predetermined threshold, and if quantization of the object audio signal, that is, generation of the quantized MDCT coefficient is completed by the time t12, the encoded audio signal of the frame to be processed can be output (transmitted) without delay. In other words, an underflow does not occur if the processing for generating the quantized MDCT coefficient is completed by the time t12.

A time t13 is a time when output of the encoded audio signal of the frame to be processed, that is, an encoded bit stream is started. In this example, a time from the time t11 to the time t13 is 21 msec.

Furthermore, a hatched (shaded) rectangular portion indicates a time required to execute processing of which a required calculation amount (calculation amount) is substantially fixed (hereinafter, also referred to as invariable processing), regardless of the object audio signal, in processing executed before the quantized MDCT coefficient is obtained from the object audio signal. More specifically, the hatched rectangular portion indicates a time needed until the invariable processing is completed. For example, the time-frequency transform and the calculation of the auditory psychological parameter are the invariable processing.

On the other hand, a rectangular portion not hatched indicates a time required to execute processing of which a required calculation amount, that is, a processing time changes according to the object audio signal (hereinafter, also referred to as variable processing), in the processing executed before the quantized MDCT coefficient is obtained from the object audio signal. For example, the bit allocation processing is the variable processing.

The processing progress monitoring unit 334 specifies a time required until the invariable processing or the variable processing is completed, by monitoring a progress status of the processing by the time-frequency transform unit 52 to the bit allocation unit 54 or monitoring an occurrence status of interruption processing of the OS or the like. Note that the time required until the invariable processing or the variable processing is completed changes due to the occurrence of the interruption processing of the OS or the like.

For example, the processing progress monitoring unit 334 generates information indicating the time required until the invariable processing is completed and the time required until the variable processing is completed as the progress information, and supplies the progress information to the processing completion availability determination unit 335.

For example, in the example indicated by an arrow Q11, the invariable processing and the variable processing are completed (end) by the time t12 to be the threshold. That is, the quantized MDCT coefficient can be obtained by the time t12.

Therefore, the processing completion availability determination unit 335 supplies a determination result indicating that the processing for encoding the object audio signal is completed within the predetermined time, that is, by the time when the output of the encoded audio signal should be started, to the processing progress monitoring unit 334.

Furthermore, for example, in the example indicated by an arrow Q12, the invariable processing is completed by the time t12. However, since the processing time of the variable processing is long, the variable processing is not completed by the time t12. In other words, a completion time of the variable processing slightly exceeds the time t12.

Therefore, the processing completion availability determination unit 335 supplies a determination result indicating that the processing for encoding the object audio signal is not completed within the predetermined time, to the processing progress monitoring unit 334. More specifically, the processing completion availability determination unit 335 supplies a determination result indicating that it is necessary to terminate the bit allocation processing, to the processing progress monitoring unit 334.

In this case, for example, the processing progress monitoring unit 334 instructs the bit allocation unit 54 to terminate the bit allocation processing, more specifically, the bit allocation loop processing, according to the determination result supplied from the processing completion availability determination unit 335.

Then, the bit allocation unit 54 terminates the bit allocation loop processing. However, since the bit allocation unit 54 executes at least minimum quantization processing, although a quality is deteriorated, the quantized MDCT coefficient can be obtained without the underflow.

Moreover, for example, in the example indicated by an arrow Q13, since the interruption processing occurs in the OS, the invariable processing is not completed by the time t12, the underflow occurs.

Then, the processing completion availability determination unit 335 supplies a determination result indicating that the processing for encoding the object audio signal is not completed within the predetermined time, to the processing progress monitoring unit 334 and the encoded Mute data insertion unit 336. More specifically, the processing completion availability determination unit 335 supplies a determination result indicating that it is necessary to output the encoded Mute data, to the processing progress monitoring unit 334 and the encoded Mute data insertion unit 336.

In this case, the time-frequency transform unit 52 to the variable length encoding unit 332 stops (terminates) the processing being executed, and the encoded Mute data is inserted by the encoded Mute data insertion unit 336.

Next, the encoded Mute data will be described. Before describing the encoded Mute data, first, the encoded audio signal will be described.

As described above, the encoded audio signal is supplied for each frame from the variable length encoding unit 332 to the output buffer 333. However, more specifically, the coded data including the encoded audio signal is supplied. Note that, here, it is assumed that the variable length encoding on the quantized MDCT coefficient be performed compliant with the MPEG-H 3D Audio standard, for example.

For example, the coded data for one frame includes at least an Indep flag (independency flag), an encoded audio signal of a current frame (encoded quantized MDCT coefficient), a preroll frame flag indicating whether or not there is data regarding a preroll frame (PreRollFrame). The Indep flag is flag information indicating whether or not the current frame is a frame encoded by using prediction or a difference.

For example, a value “1” of the Indep flag, that is, Indep=1 indicates that the current frame is a frame encoded without using the prediction, the difference, or the like. In other words, Indep=1 indicates that the encoded audio signal of the current frame is an absolute value of the quantized MDCT coefficient, that is, the encoded quantized MDCT coefficient.

Therefore, on the decoder 81 side, that is, a reproduction device side, in a case where the encoded bit stream is reproduced from the middle, it is possible to start the processing (reproduction) from the frame of Indep=1. In other words, the frame in which Indep=1 is a randomly accessible frame.

For example, a value “0” of the Indep flag, that is, Indep=0 indicates that the current frame is a frame encoded using the prediction or the difference. In other words, Indep=0 indicates that the encoded audio signal of the current frame is obtained by encoding a difference value between the quantized MDCT coefficient of the current frame and a quantized MDCT coefficient of a frame immediately before the current frame. Therefore, the frame in which Indep=0 is a frame that cannot be randomly accessed, that is, a frame that is not an access destination of random access.

Furthermore, the preroll frame flag is flag information indicating whether or not an encoded audio signal of the preroll frame is included in the coded data of the current frame.

For example, in a case where a value of the preroll frame flag is “1”, the encoded audio signal (encoded quantized MDCT coefficient) of the preroll frame is included in the coded data of the current frame.

In this case, the coded data of the current frame includes the Indep flag, the encoded audio signal of the current frame, the preroll frame flag, and the encoded audio signal of the preroll frame.

On the other hand, in a case where the value of the preroll frame flag is “0”, the encoded audio signal of the preroll frame is not included in the coded data of the current frame.

Note that the preroll frame is a frame that can be randomly accessed, that is, a frame immediately before the frame in which Indep=1, in terms of time.

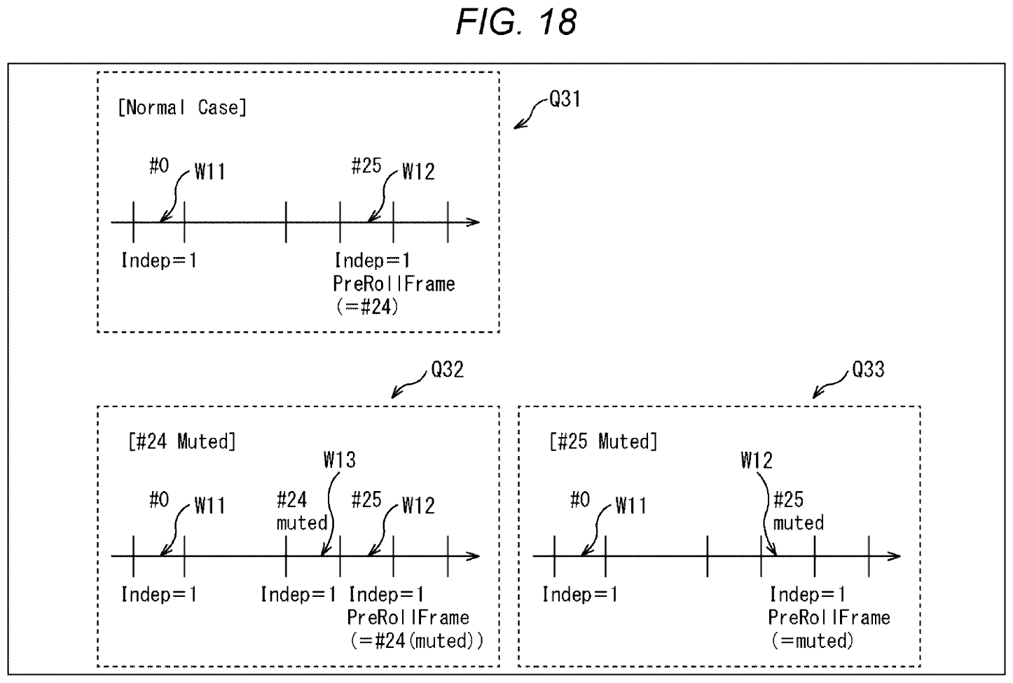

Here, an example of a bit stream including coded data (encoded audio signal) of each of the plurality of frames will be described with reference to FIG. 18.

Note that, in FIG. 18, #x represents a frame number of a frame (time frame) of an object audio signal. Furthermore, a frame in which characters “Indep=1” are not written is assumed as the frame in which Indep=0.

For example, “#0” represents a zero-th frame (0-th) with zero origin, that is, the first frame, and “#25” represents a 25-th frame. Hereinafter, a frame with the frame number “#x” is described as a frame #x.

In FIG. 18, in a portion indicated by an arrow Q31, a bit stream obtained by a normal encoding process, performed in a case where the processing completion availability determination unit 335 determines that the processing is completed within the predetermined time is illustrated. In particular, in this example, the frame #0 indicated by an arrow W11 and the frame #25 indicated by an arrow W12 are the frames in which Indep=1, that is, the randomly accessible frames.

For example, if it is assumed that Indep=1 in all the frames, decoding (reproduction) can be started from any frame. However, since the encoding efficiency is significantly deteriorated, encoding is performed for each several tens of frames as assuming Indep=1 in general. Therefore, description will be made as assuming that Indep=1 is set for every 25 frames in FIG. 18.

Furthermore, characters “PreRollFrame(=#24)” written in the portion of the frame #25 represent that an encoded audio signal of a frame #24 that is a preroll frame for the frame #25 is stored in the coded data (bit stream) of the frame #25.

For example, in a case where decoding is started from the frame #25, the encoded audio signal of the frame #25 includes only an odd function component of a signal (object audio signal), due to property of the MDCT. Therefore, if decoding is performed using only the encoded audio signal of the frame #25, it is not possible to reproduce the frame #25 as complete data, and an abnormal noise occurs.

Therefore, in order to prevent the occurrence of such an abnormal noise, the encoded audio signal of the frame #24 that is the preroll frame is stored in the coded data of the frame #25.

Then, in a case where decoding is started from the frame #25, the encoded audio signal of the frame #24, more specifically, an even function component of the encoded audio signal is extracted (extracted) from the coded data of the frame #25 and is synthesized with the odd function component of the frame #25.

As a result, as a decoding result of the frame #25, the complete object audio signal can be obtained, and the occurrence of the abnormal noise at the time of reproduction can be prevented.

Furthermore, in a portion indicated by an arrow Q32, a bit stream obtained in a case where the processing completion availability determination unit 335 determines that the processing is not completed within the predetermined time is illustrated, in the frame #24. That is, in the portion indicated by the arrow Q32, an example is illustrated in which the encoded Mute data is inserted in the frame #24.

Note that, hereinafter, a frame in which the encoded Mute data is inserted is particularly referred to as a mute frame.

In this example, the frame #24 indicated by an arrow W13 is the mute frame, and this frame #24 is a frame immediately before (preroll frame) the randomly accessible frame #25.

In the frame #24 that is the mute frame, the encoded Mute data calculated in advance on the basis of the number of objects at the time of initialization is inserted into the bit stream as the encoded audio signal of the frame #24. More specifically, the coded data including the encoded Mute data is inserted into the bit stream.

The encoded Mute data generation unit 362 generates the encoded Mute data by performing arithmetic coding on the quantized MDCT coefficient (quantized value of Mute data) with the MDCT coefficient “0” as assuming that the frame #24 is the randomly accessible frame, that is, Indep=1.

In particular, the encoded Mute data is generated using only the quantized MDCT coefficient (silent data) for one frame corresponding to the frame to be processed and without using a quantized MDCT coefficient corresponding to a frame immediately before the frame to be processed. That is, the encoded Mute data is generated without using a difference from the immediately previous frame and context of the immediately previous frame.

This is because data (quantized MDCT coefficient) of a frame #23 immediately before the frame #24 does not exist at the time of initialization, that is, at the time when the encoded Mute data is generated.

In this way, in a case where the mute frame is not the randomly accessible frame, as the coded data of the mute frame, coded data including the Indep flag with the value of “1”, the encoded Mute data as the encoded audio signal of the current frame that is the mute frame, and the preroll frame flag with the value of “0” is generated. In this case, although the value of the Indep flag of the mute frame is “1”, on the decoder 81 side, decoding is not started from the mute frame.

Furthermore, in this example, the next frame #25 of the frame #24, which is the mute frame, is the randomly accessible frame, that is, the frame of Indep=1.

Therefore, in the coded data of the frame #25, the encoded Mute data of the frame #24 that is the preroll frame of the frame #25 is stored as the encoded audio signal of the preroll frame. In this case, for example, the encoded Mute data insertion unit 336 inserts (stores) the encoded Mute data of the frame #24 into the coded data of the frame #25 held by the output buffer 333.

In a portion indicated by an arrow Q33, an example is illustrated in which the randomly accessible frame #25 is the mute frame.

In the frame #25 that is the mute frame, coded data including the encoded Mute data calculated in advance on the basis of the number of objects at the time of initialization is inserted into the bit stream. As in the example indicated by the arrow Q32, the encoded Mute data is obtained by performing arithmetic coding on the quantized MDCT coefficient with the MDCT coefficient “0” as assuming that Indep=1.

Furthermore, since the frame #25 is the randomly accessible frame, the encoded audio signal of the preroll frame is stored in the coded data of the frame #25. In this case, the encoded Mute data is assumed as the encoded audio signal of the preroll frame.

Therefore, in a case where the mute frame is a randomly accessible frame, as coded data of the mute frame, coded data including the Indep flag having the value “1”, encoded Mute data as an encoded audio signal of the current frame that is the mute frame, a preroll frame flag having the value “1”, and encoded Mute data as an encoded audio signal of the preroll frame.

As described above, the encoded Mute data insertion unit 336 inserts the encoded Mute data, according to the type of the current frame such as whether or not the current frame that is the mute frame is the preroll frame or the randomly accessible frame.

According to the present technology, even in a case of the MPEG-H using the context-based arithmetic coding technology is the encoding method in the software-based encoding device using the OS such as Linux (registered trademark), the occurrence of the underflow can be prevented.

In particular, according to the present technology, for example, even in a case where encoding of the object audio signal is not completed due to other processing loads generated in the OS, the occurrence of the underflow can be prevented.

### <Configuration Example of Coded Data>

Subsequently, a configuration example of the coded data storing the encoded audio signal will be described.

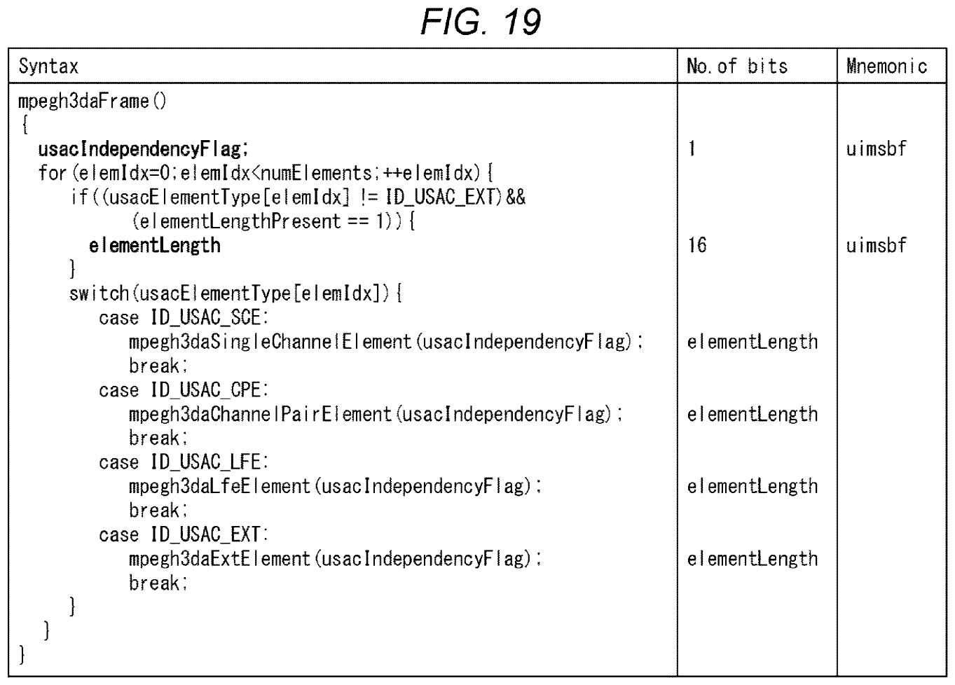

FIG. 19 illustrates a syntax example of coded data.

In this example, “usacIndependencyFlag” represents the Indep flag.

Furthermore, “mpegh3daSingleChannelElement (usacIndependencyFlag)” represents the object audio signal, more specifically, the encoded audio signal. The encoded audio signal is data of the current frame.

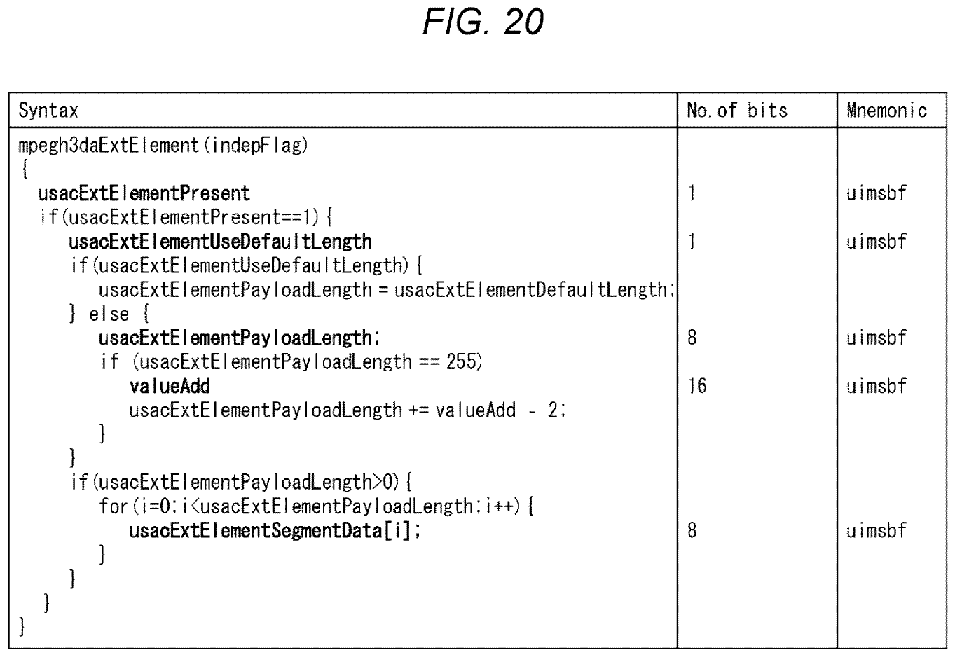

Moreover, the coded data stores extension data indicated by “mpegh3daExtElement (usacIndependencyFlag)”. This extension data has a configuration illustrated in FIG. 20, for example.

In the example illustrated in FIG. 20, segment data indicated by “usacExtElementSegmentData [i]” is appropriately stored in the extension data.

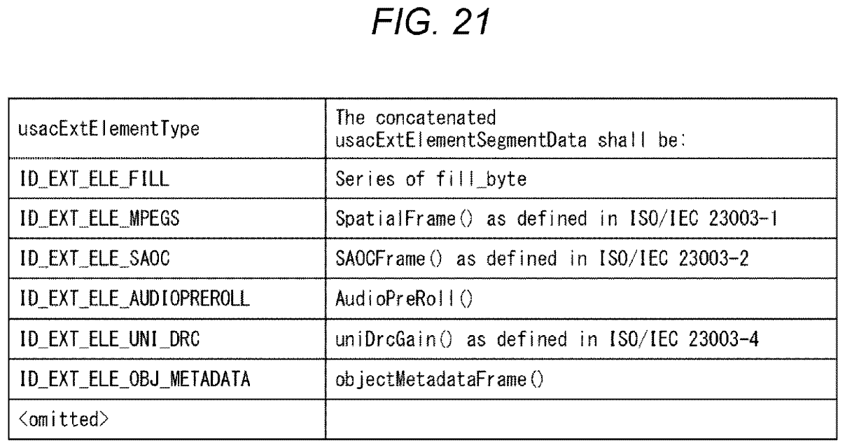

The data stored in the segment data and an order of storing the data are determined by usacExtElementType that is config data as illustrated in FIG. 21, for example.

In the example illustrated in FIG. 21, in a case where usacExtElementType is “ID_EXT_ELE_AUDIOPREROLL”, “AudioPreRoll( )” is stored in the segment data.

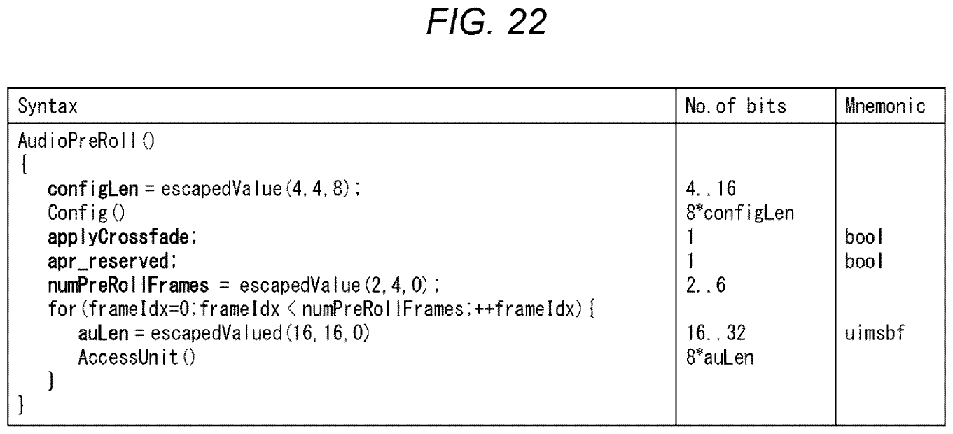

This “AudioPreRoll( )” is data having a configuration illustrated in FIG. 22, for example.

In this example, an encoded audio signal of a frame before the current frame indicated by “AccessUnit( )” is stored by the number indicated by “numPreRollFrames”.

In particular, here, the single encoded audio signal indicated by “AccessUnit( )” is the encoded audio signal of the preroll frame. Furthermore, by increasing the number indicated by “numPreRollFrames”, it is possible to store an encoded audio signal of a frame further ahead (past side) in terms of time.

### <Description of Initialization Processing>

Next, an operation of the encoder 11 illustrated in FIG. 14 will be described.

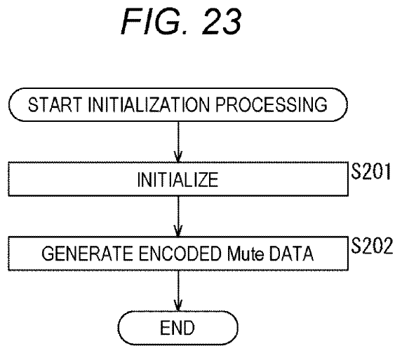

First, initialization processing executed when the encoder 11 is activated or the like will be described with reference to the flowchart in FIG. 23.

In step S201, the initialization processing unit 361 performs initialization on the basis of the supplied initialization information. For example, the initialization processing unit 361 resets a parameter used at the time of the encoding processing by each unit of the encoder 11 or resets the output buffer 333.

Furthermore, the initialization processing unit 361 generates the object number information on the basis of the initialization information and supplies the object number information to the encoded Mute data generation unit 362.

In step S202, the encoded Mute data generation unit 362 generates the encoded Mute data on the basis of the object number information supplied from the initialization processing unit 361 and supplies the encoded Mute data to the encoded Mute data insertion unit 336.

For example, as described with reference to FIG. 18, the encoded Mute data generation unit 362 generates the encoded Mute data by performing arithmetic coding on the quantized MDCT coefficient with the MDCT coefficient “0” as assuming that Indep=1. Furthermore, the encoded Mute data is generated by the number of objects indicated by the object number information. If the encoded Mute data is generated, the initialization processing ends.

As described above, the encoder 11 performs initialization and generates the encoded Mute data. By generating the encoded Mute data in advance before encoding, at the time of encoding the object audio signal, the encoded Mute data is inserted as needed, and the occurrence of the underflow can be prevented.

### <Description of Encoding Processing>

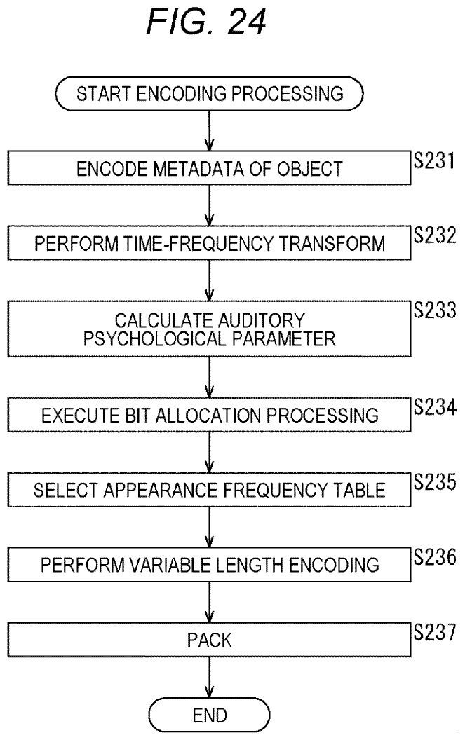

When the initialization processing ends, thereafter, the encoder 11 executes the encoding processing and encoded Mute data insertion processing in parallel at any timing. First, the encoding processing by the encoder 11 will be described with reference to the flowchart in FIG. 24.

Note that, since processing in steps S231 to S233 is similar to the processing in steps S11, S13, and S14 in FIG. 3, description thereof is omitted.

In step S234, the bit allocation unit 54 executes the bit allocation processing on the basis of the MDCT coefficient supplied from the time-frequency transform unit 52 and the auditory psychological parameter supplied from the auditory psychological parameter calculation unit 53.

In the bit allocation processing, the minimum quantization processing and the additional bit allocation loop processing are executed on the MDCT coefficient for each scale factor band, for each object, in arbitrary order.

The bit allocation unit 54 supplies the quantized MDCT coefficient obtained by the bit allocation processing to the context processing unit 331 and the variable length encoding unit 332.

In step S235, the context processing unit 331 selects the appearance frequency table used to encode the quantized MDCT coefficient, on the basis of the quantized MDCT coefficient supplied from the bit allocation unit 54.

For example, as described with reference to FIG. 13, the context processing unit 331 calculates a context value on the basis of a quantized MDCT coefficient of a frequency in the vicinity of the frequency (scale factor band) of the quantized MDCT coefficient to be processed, in the current frame and the frame immediately before the current frame, for the quantized MDCT coefficient to be processed in the current frame.

Then, the context processing unit 331 selects the appearance frequency table used to encode the quantized MDCT coefficient to be processed on the basis of the context value, and supplies the appearance frequency table index indicating the selection result to the variable length encoding unit 332.

In step S236, the variable length encoding unit 332 performs variable length encoding on the quantized MDCT coefficient supplied from the bit allocation unit 54, on the basis of the appearance frequency table indicated by the appearance frequency table index supplied from the context processing unit 331.

The variable length encoding unit 332 supplies the coded data including the encoded audio signal obtained by the variable length encoding, more specifically, the encoded audio signal of the current frame obtained by performing variable length encoding to the output buffer 333 and makes the output buffer 333 hold the coded data.

That is, as described with reference to FIG. 18, the variable length encoding unit 332 generates the coded data including at least the Indep flag, the encoded audio signal of the current frame, and the preroll frame flag and makes the output buffer 333 hold the coded data. As described above, the coded data includes the encoded audio signal of the preroll frame, according to the value of the preroll frame flag, as appropriate.

Note that, each processing in steps S232 to S236 described above is executed for each object or each frame, according to the result of the processing completion availability determination by the processing completion availability determination unit 335. That is, according to the result of the processing completion availability determination, a part or all of the plurality of pieces of processing is not executed, or the execution of the processing is stopped (terminated) halfway.

Furthermore, by the encoded Mute data insertion processing to be described later, the encoded Mute data is appropriately inserted into the bit stream including the encoded audio signal (coded data) for each object of each frame held by the output buffer 333.

The output buffer 333 supplies the holding encoded audio signal (coded data) to the packing unit 23 at an appropriate timing.

If the encoded audio signal (coded data) is supplied from the output buffer 333 to the packing unit 23 for each frame, thereafter, the processing in step S237 is executed, and the encoding processing ends. However, since the processing in step S237 is similar to the processing in step S17 in FIG. 3, description thereof is omitted. Note that, more specifically, the encoded metadata and the coded data including the encoded audio signal are packed in step S237, and an encoded bit stream obtained as a result is output.

As described above, the encoder 11 performs variable length encoding, packs the encoded audio signal and the encoded metadata obtained as a result, and outputs the encoded bit stream. In this way, the data of the object can be efficiently transmitted.

### <Description of Encoded Mute Data Insertion Processing>

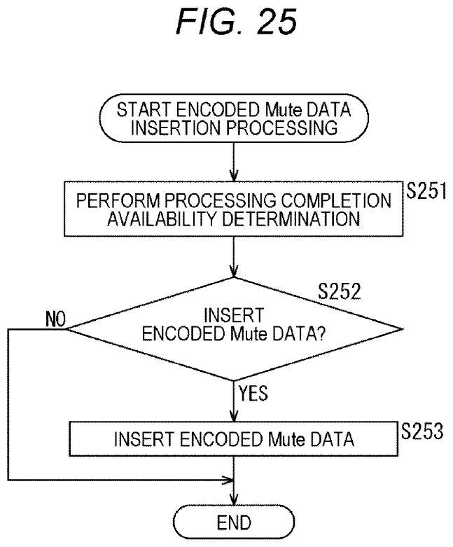

Next, the encoded Mute data insertion processing, executed at the same time as the encoding processing by the encoder 11, will be described with reference to the flowchart in FIG. 25. For example, the encoded Mute data insertion processing is executed for each frame of the object audio signal or for each object.

In step S251, the processing completion availability determination unit 335 performs processing completion availability determination.

For example, if the encoding processing described above is started, monitoring of the progress of each processing executed by the processing progress monitoring unit 334, the time-frequency transform unit 52 to the bit allocation unit 54, the context processing unit 331, and the variable length encoding unit 332 is started, and the progress information is generated. Then, the processing progress monitoring unit 334 supplies the generated progress information to the processing completion availability determination unit 335.

Then, the processing completion availability determination unit 335 performs processing completion availability determination on the basis of the progress information supplied from the processing progress monitoring unit 334 and supplies a determination result to the processing progress monitoring unit 334 and the encoded Mute data insertion unit 336.

For example, in a case where the variable length encoding by the variable length encoding unit 332 is not completed by a time when the packing unit 23 should start packing even if only the minimum quantization processing is executed as the bit allocation processing, it is determined that the processing for encoding the object audio signal is not completed with the predetermined time. Then, a determination result indicating that the processing for encoding the object audio signal is not completed within the predetermined time, more specifically, a determination result indicating that it is necessary to output the encoded Mute data is supplied to the processing progress monitoring unit 334 and the encoded Mute data insertion unit 336.

Furthermore, for example, if only the minimum quantization processing is executed in the bit allocation processing or if the bit allocation loop processing is terminated halfway, variable length encoding by the variable length encoding unit 332 may be completed by the time when the packing unit 23 should start packing. In such a case, although it is determined that the processing for encoding the object audio signal is not completed within the predetermined time, the determination result is not supplied to the encoded Mute data insertion unit 336 and is supplied only to the processing progress monitoring unit 334. More specifically, a determination result indicating that it is necessary to terminate the bit allocation processing is supplied to the processing progress monitoring unit 334.

The processing progress monitoring unit 334 controls execution of the processing appropriately executed by the time-frequency transform unit 52 to the bit allocation unit 54, the context processing unit 331, and the variable length encoding unit 332, according to the determination result supplied from the processing completion availability determination unit 335.

That is, for example, as described with reference to FIG. 17, the processing progress monitoring unit 334 appropriately instructs each processing block of the time-frequency transform unit 52 to the variable length encoding unit 332 to stop execution of processing to be executed, to terminate processing in progress, or the like.

Specifically, for example, it is assumed that a determination result indicating that the processing for encoding the object audio signal is not completed within the predetermined time in a predetermined frame, more specifically, a determination result indicating that it is necessary to output the encoded Mute data be supplied to the processing progress monitoring unit 334.

In such a case, the processing progress monitoring unit 334 instructs the time-frequency transform unit 52 to the variable length encoding unit 332 to stop the processing on the predetermined frame executed by the time-frequency transform unit 52 to the variable length encoding unit 332 or the processing in progress. Then, in the encoding processing described with reference to FIG. 24, the processing in steps S232 to S236 is stopped or terminated halfway.

Therefore, the variable length encoding unit 332 does not perform variable length encoding of the quantized MDCT coefficient in the predetermined frame, and an encoded audio signal (coded data) of the predetermined frame is not supplied from the variable length encoding unit 332 to the output buffer 333.

Furthermore, for example, it is assumed that a determination result indicating that it is necessary to terminate the bit allocation processing be supplied to the processing progress monitoring unit 334 in the predetermined frame. In such a case, the processing progress monitoring unit 334 instructs the bit allocation unit 54 to execute only the minimum quantization processing or to terminate the bit allocation loop processing.

Then, in the encoding processing described with reference to FIG. 24, the bit allocation processing in response to the instruction by the processing progress monitoring unit 334 is executed in step S234.

In step S252, the encoded Mute data insertion unit 336 determines whether or not to insert the encoded Mute data, in other words, whether or not the current frame to be processed is a mute frame, on the basis of the determination result supplied from the processing completion availability determination unit 335.

For example, in step S252, in a case where the determination result indicating that the processing for encoding the object audio signal is not completed within the predetermined time, more specifically, the determination result indicating that it is necessary to output the encoded Mute data is supplied as the result of the processing completion availability determination, it is determined to insert the encoded Mute data.

In a case where it is determined not to insert the encoded Mute data in step S252, the processing in step S253 is not executed, and the encoded Mute data insertion processing ends.

For example, in a case where the determination result indicating that it is necessary to terminate the bit allocation processing is supplied to the processing progress monitoring unit 334, it is determined not to insert the encoded Mute data in step S252. Therefore, the encoded Mute data insertion unit 336 does not insert the encoded Mute data.

Note that, in a case where the current frame to be processed is a randomly accessible frame and the frame immediately before the current frame is a mute frame, the encoded Mute data insertion unit 336 inserts the encoded Mute data of the preroll frame.

That is, for example, as indicated by the arrow Q32 in FIG. 18, the encoded Mute data insertion unit 336 inserts the encoded Mute data into the coded data of the current frame held by the output buffer 333, as the encoded audio signal of the preroll frame.

In a case where it is determined in step S252 to insert the encoded Mute data, the encoded Mute data insertion unit 336 inserts the encoded Mute data into the coded data of the current frame according to the type of current frame to be processed in step S253.

More specifically, for example, as described with reference to FIG. 18, the encoded Mute data insertion unit 336 generates the coded data of the current frame including the Indep flag with the value “1”, the encoded Mute data as the encoded audio signal of the current frame to be processed, and the preroll frame flag.

At this time, in a case where the current frame is a randomly accessible frame, the encoded Mute data insertion unit 336 stores the encoded Mute data, as the encoded audio signal of the preroll frame, in the coded data of the current frame to be processed.

Then, the encoded Mute data insertion unit 336 inserts the coded data of the current frame into a portion, corresponding to the current frame, in the bit stream including the coded data of each frame held by the output buffer 333.

Note that, in a case where the current frame is the preroll frame of the next frame (immediately after) of the current frame as described above, the encoded Mute data is inserted into the coded data of the next frame at an appropriate timing, as the encoded audio signal of the preroll frame.

Furthermore, in a case where the current frame is a mute frame, the variable length encoding unit 332 may generate the coded data of the current frame that does not store the encoded audio signal and supply the coded data to the output buffer 333. In such a case, the encoded Mute data insertion unit 336 inserts the encoded Mute data, as the encoded audio signal of the current frame or the preroll frame, in the coded data of the current frame held by the output buffer 333.

If the encoded Mute data is inserted into the bit stream held by the output buffer 333, the encoded Mute data insertion processing ends.

As described above, the encoder 11 inserts the encoded Mute data as appropriate. In this way, the occurrence of the underflow can be prevented.

Note that, even in a case where the encoded Mute data is inserted as necessary, the bit allocation unit 54 may execute the bit allocation processing in order indicated by the priority information. In such a case, the bit allocation unit 54 executes processing similar to the bit allocation processing described with reference to FIG. 4, and for example, inserts the encoded Mute data regarding an object for which the minimum quantization processing is not completed.

### <Configuration Example of Decoder>

Furthermore, the decoder 81 using the encoded bit stream output by the encoder 11 illustrated in FIG. 14 as input is configured as illustrated in FIG. 6, for example.

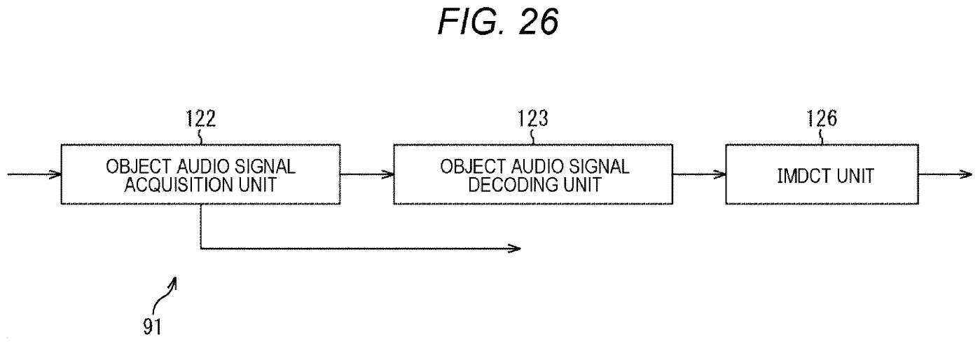

However, a configuration of the unpacking/decoding unit 91 of the decoder 81 is a configuration illustrated in FIG. 26, for example. Note that, in FIG. 26, portions corresponding to those in a case of FIG. 7 are denoted by the same reference numerals, and description thereof will be omitted as appropriate.

The unpacking/decoding unit 91 illustrated in FIG. 26 includes an object audio signal acquisition unit 122, an object audio signal decoding unit 123, and an IMDCT unit 126.

The object audio signal acquisition unit 122 acquires the encoded audio signal (coded data) of each object from the supplied encoded bit stream and supplies the encoded audio signal to the object audio signal decoding unit 123.

Furthermore, the object audio signal acquisition unit 122 acquires the encoded metadata of each object from the supplied encoded bit stream, decodes the acquired encoded metadata, and supplies metadata obtained as a result, to the rendering unit 92.

### <Description of Decoding Processing>

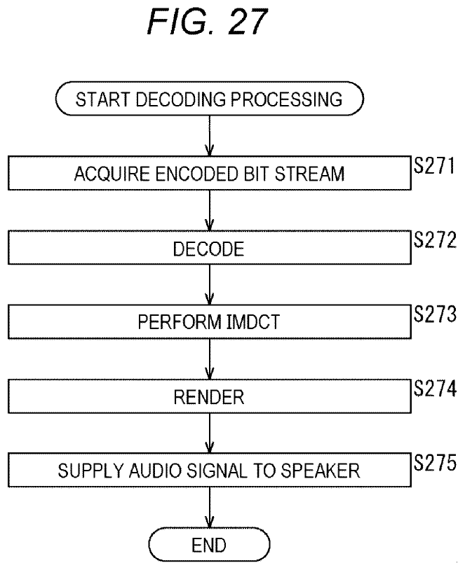

Next, an operation of the decoder 81 will be described. That is, hereinafter, decoding processing executed by the decoder 81 will be described with reference to the flowchart in FIG. 27.

In step S271, the unpacking/decoding unit 91 acquires (receives) the encoded bit stream transmitted from the encoder 11.

In step S272, the unpacking/decoding unit 91 decodes the encoded bit stream.

That is, the object audio signal acquisition unit 122 of the unpacking/decoding unit 91 acquires the encoded metadata of each object from the encoded bit stream, decodes the acquired encoded metadata, and supplies the metadata obtained as a result, to the rendering unit 92.

Furthermore, the object audio signal acquisition unit 122 acquires the encoded audio signal (coded data) of each object from the encoded bit stream and supplies the encoded audio signal to the object audio signal decoding unit 123.

Then, the object audio signal decoding unit 123 decodes the encoded audio signal supplied from the object audio signal acquisition unit 122 and supplies an MDCT coefficient obtained as a result, to the IMDCT unit 126.

In step S273, the IMDCT unit 126 performs IMDCT on the basis of the MDCT coefficient supplied from the object audio signal decoding unit 123 to generate the audio signal of each object, and supplies the audio signal to the rendering unit 92.

If the IMDCT is performed, thereafter, the processing in steps S274 and S275 is executed, and the decoding processing ends. However, these processing is similar to the processing in steps S83 and S84 in FIG. 8, description thereof is omitted.

As described above, the decoder 81 decodes the encoded bit stream and reproduces sound. In this way, reproduction can be performed without causing the underflow, that is, without interrupting the sound.

### Fifth Embodiment

### <Configuration Example of Encoder>

By the way, objects included in content include an important object that is not desired to be masked from other objects. Furthermore, even in a single object, a plurality of frequency components included in an audio signal of the object includes an important frequency component that is not desired to be masked from the other objects.

Therefore, for the object and the frequency that are not desired to be masked from the other objects, an auditory masking amount regarding sounds from all the other objects in a three-dimensional space of the object, that is, an allowable upper limit value of a masking threshold (space masking threshold) (hereinafter, also referred to as allowable masking threshold) may be set.

The masking threshold is a threshold of a boundary of a sound pressure at which sound cannot be heard due to masking, and sound smaller than the threshold is not audibly perceived. Note that, in the following description, frequency masking is simply referred to as masking. Successive masking may be used instead of the frequency masking, and both of the frequency masking and the successive masking can be used. The frequency masking is a phenomenon in which sound of a certain frequency masks sound of another frequency so as to difficult to hear the sound of the another frequency, when sounds of a plurality of frequencies are reproduced at the same time. The successive masking is a phenomenon in which, when certain sound is reproduced, sounds reproduced before and after in terms of time are masked to make it difficult to be heard.

In a case where setting information indicating such an upper limit value (allowable masking threshold) is set, the setting information can be used for the bit allocation processing, more specifically, calculation of an auditory psychological parameter.

The setting information is information regarding the important object that is desired not to be masked from the other objects and the masking threshold of the frequency. For example, the setting information includes information indicating an object ID indicating an object (audio signal) to which the allowable masking threshold, that is, the upper limit value is set and a frequency to which the upper limit value is set, information indicating the set upper limit value (allowable masking threshold), or the like. That is, for example, in the setting information, the upper limit value (allowable masking threshold) is set for each frequency, for each object.

By using the setting information, it is possible to improve a sound quality of entire content or improve an encoding efficiency, by preferentially allocating a bit to an object or a frequency that is considered important by a content creator and improving a sound quality ratio than the other objects and frequencies.

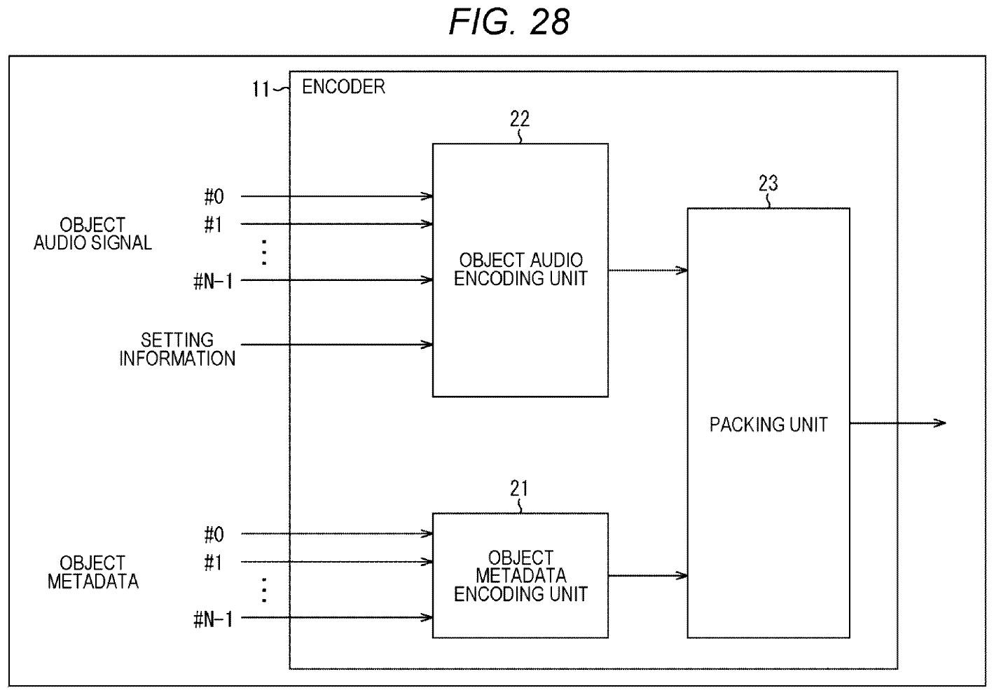

FIG. 28 is a diagram illustrating a configuration example of an encoder 11 in a case where the setting information is used. Note that, in FIG. 28, portions corresponding to those in a case of FIG. 1 are denoted by the same reference numerals, and description thereof will be omitted as appropriate.

The encoder 11 illustrated in FIG. 28 includes an object metadata encoding unit 21, an object audio encoding unit 22, and a packing unit 23.

In this example, unlike the example illustrated in FIG. 1, a Priority value that is included in metadata of an object is not supplied to the object audio encoding unit 22.

The object audio encoding unit 22 encodes an audio signal of each of N objects that has been supplied, according to the MPEG-H standard or the like, on the basis of the supplied setting information, and supplies an encoded audio signal obtained as a result, to the packing unit 23.

Note that the upper limit value indicated by the setting information may be set (input) by a user or may be set on the basis of the audio signal by the object audio encoding unit 22.

Specifically, for example, the object audio encoding unit 22 may perform music analysis or the like on the basis of the audio signal of each object and set the upper limit value, on the basis of an analysis result such as a genre or a melody of content obtained as a result.

For example, regarding a Vocal (vocal) object, an important frequency band for Vocal is automatically determined on the basis of the analysis result, and it is possible to set the upper limit value on the basis of the determination result.

Furthermore, as the upper limit value (allowable masking threshold) indicated by the setting information, a common value for all the frequencies may be set to the single object, or the upper limit value may be set to the single object for each frequency. In addition, the common upper limit value for all the frequencies or the upper limit value for each frequency may be set to the plurality of objects.

### <Configuration Example of Object Audio Encoding Unit>

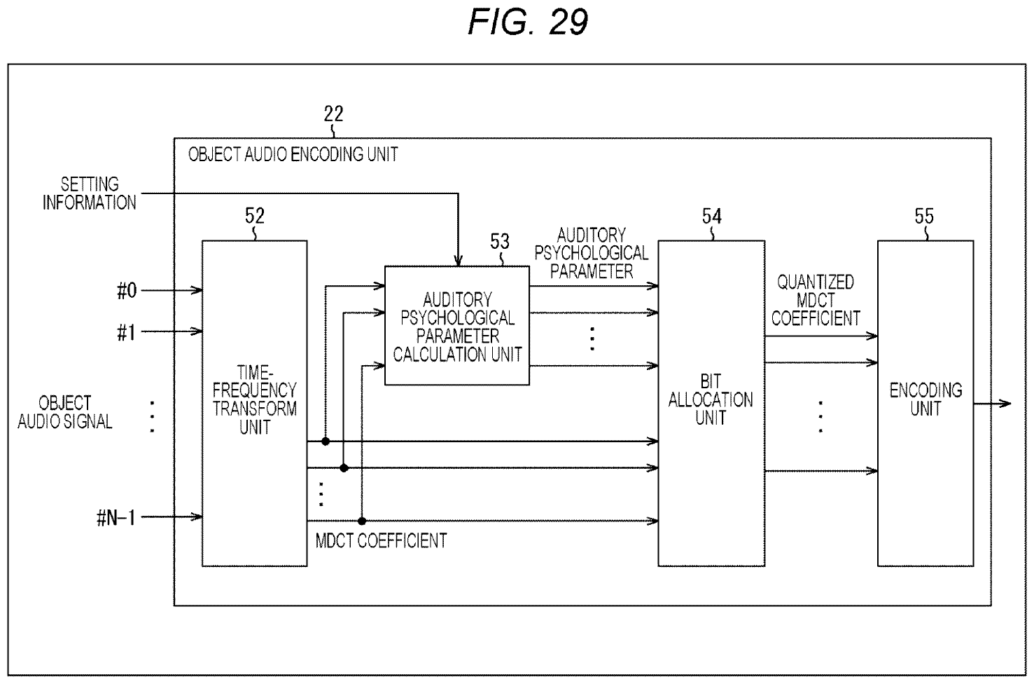

Furthermore, the object audio encoding unit 22 of the encoder 11 illustrated in FIG. 28 is configured as illustrated in FIG. 29, for example. Note that, in FIG. 29, portions corresponding to those in a case of FIG. 2 are denoted by the same reference numerals, and description thereof will be omitted as appropriate.

In the example illustrated in FIG. 29, the object audio encoding unit 22 includes a time-frequency transform unit 52, an auditory psychological parameter calculation unit 53, a bit allocation unit 54, and an encoding unit 55.

The time-frequency transform unit 52 performs time-frequency transform using an MDCT on the supplied audio signal of each object, and supplies an MDCT coefficient obtained as a result to the auditory psychological parameter calculation unit 53 and the bit allocation unit 54.

The auditory psychological parameter calculation unit 53 calculates an auditory psychological parameter on the basis of the supplied setting information and the MDCT coefficient supplied from the time-frequency transform unit 52 and supplies the calculated auditory psychological parameter to the bit allocation unit 54.

Note that, here, an example will be described in which the auditory psychological parameter calculation unit 53 calculates the auditory psychological parameter on the basis of the setting information and the MDCT coefficient. However, the auditory psychological parameter may be calculated on the basis of the setting information and the audio signal.

The bit allocation unit 54 executes the bit allocation processing on the basis of an MDCT coefficient supplied from the time-frequency transform unit 52 and an auditory psychological parameter supplied from the auditory psychological parameter calculation unit 53.

In the bit allocation processing, bit allocation based on an auditory psychological model for calculating and evaluating a quantized bit and a quantization noise of each scale factor band is performed. Then, the MDCT coefficient is quantized for each scale factor band on the basis of the result of the bit allocation, and a quantized MDCT coefficient is obtained (generated).

The bit allocation unit 54 supplies the quantized MDCT coefficient for each scale factor band of each object obtained in this way to the encoding unit 55, as a quantization result of each object, more specifically, a quantization result of the MDCT coefficient of each object.

By the bit allocation processing as described above, a part of quantized bits of the scale factor band in which the quantization noise that is generated in quantization of the MDCT coefficient is masked and is not perceived is allocated to a scale factor band in which the quantization noise is easily perceived.

At this time, bits are preferentially allocated to the important objects and frequencies (scale factor band), according to the setting information. In other words, the bits are appropriately allocated to the object and the frequency, to which the upper limit value is set, according to the upper limit value.

As a result, it is possible to prevent deterioration in an overall sound quality, in particular, deterioration in a sound quality of an object or frequency that is considered as important by the user (content creator) and to perform efficient quantization. That is, the encoding efficiency can be improved.

In parameter, when a quantized MDCT coefficient is calculated, the auditory psychological parameter calculation unit 53 calculates the masking threshold (auditory psychological parameter) for each frequency for each object, on the basis of the setting information. Then, at the time of the bit allocation processing by the bit allocation unit 54, a quantized bit is allocated so that a quantization noise does not exceed the masking threshold.

For example, at the time when the auditory psychological parameter is calculated, parameter adjustment is performed on the frequency to which the upper limit value is set according to the setting information, so as to reduce the allowable quantization noise, and the auditory psychological parameter is calculated.

Note that an adjustment amount of the parameter adjustment may change according to the allowable masking threshold indicated by the setting information, that is, the upper limit value. As a result, it is possible to allocate more bits to the frequency.

The encoding unit 55 encodes the quantized MDCT coefficient for each scale factor band of each object supplied from the bit allocation unit 54 and supplies an encoded audio signal obtained as a result, to the packing unit 23.

### <Description of Encoding Processing>

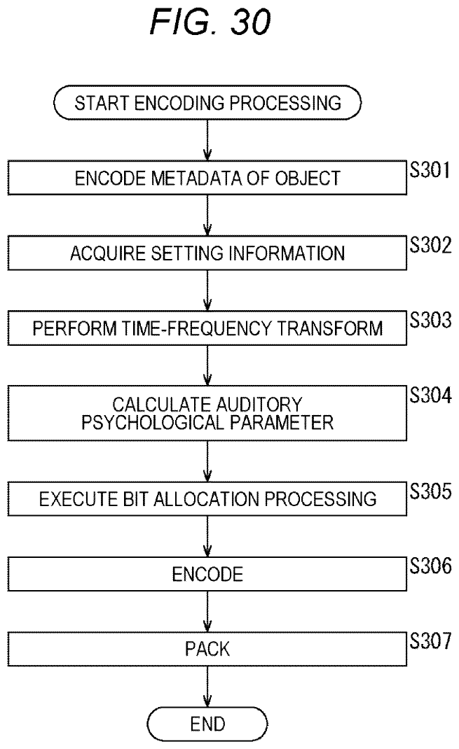

Subsequently, an operation of the encoder 11 with the configuration illustrated in FIG. 28 will be described. That is, hereinafter, the encoding processing by the encoder 11 illustrated in FIG. 28 will be described with reference to the flowchart in FIG. 30.

Note that, since processing of step S301 is similar to the processing of step S11 in FIG. 3, description thereof is omitted.

In step S302, the auditory psychological parameter calculation unit 53 acquires the setting information.

In step S303, the time-frequency transform unit 52 performs time-frequency transform using the MDCT on the supplied audio signal of each object and generates an MDCT coefficient for each scale factor band. The time-frequency transform unit 52 supplies the generated MDCT coefficient to the auditory psychological parameter calculation unit 53 and the bit allocation unit 54.

In step S304, the auditory psychological parameter calculation unit 53 calculates the auditory psychological parameter on the basis of the setting information acquired in step S302 and the MDCT coefficient supplied from the time-frequency transform unit 52, and supplies the auditory psychological parameter to the bit allocation unit 54.

At this time, the auditory psychological parameter calculation unit 53 calculates the auditory psychological parameter on the basis of the upper limit value indicated by the setting information, so as to reduce the allowable quantization noise, for the object or the frequency (scale factor band) indicated by the setting information.

In step S305, the bit allocation unit 54 executes the bit allocation processing on the basis of the MDCT coefficient supplied from the time-frequency transform unit 52 and the auditory psychological parameter supplied from the auditory psychological parameter calculation unit 53.

The bit allocation unit 54 supplies the quantized MDCT coefficient obtained by the bit allocation processing to the encoding unit 55.

In step S306, the encoding unit 55 encodes the quantized MDCT coefficient supplied from the bit allocation unit 54 and supplies the encoded audio signal obtained as a result, to the packing unit 23.

For example, the encoding unit 55 performs context-based arithmetic coding on the quantized MDCT coefficient and outputs the encoded quantized MDCT coefficient to the packing unit 23 as the encoded audio signal. Note that the encoding method is not limited to arithmetic coding, and may be any other encoding method including a Huffman coding method, other encoding methods, or the like.

In step S307, the packing unit 23 packs the encoded metadata supplied from the object metadata encoding unit 21 and the encoded audio signal supplied from the encoding unit 55 and outputs the encoded bit stream obtained as a result. If the encoded bit stream obtained by packing is output, the encoding processing ends.

As described above, the encoder 11 calculates the auditory psychological parameter on the basis of the setting information and executes the bit allocation processing. In this way, it is possible to increase the number of bits allocated to sound on an object or in a frequency band that is desired to be prioritized by the content creator, and it is possible to improve the encoding efficiency.

Note that, in this embodiment, an example has been described in which the priority information is not used for the bit allocation processing. However, the present technology is not limited to this, and even in a case where the priority information is used for the bit allocation processing, the setting information may be used to calculate the auditory psychological parameter. In such a case, the setting information is supplied to the auditory psychological parameter calculation unit 53 of the object audio encoding unit 22 illustrated in FIG. 2, and the auditory psychological parameter is calculated using the setting information. In addition, the setting information may be supplied to the auditory psychological parameter calculation unit 53 of the object audio encoding unit 22 illustrated in FIG. 15, and the setting information may be used to calculate the auditory psychological parameter.

### <Configuration Example of Computer>

Note that, the above-described series of processing may be executed by hardware or software. In a case where the series of processing is executed by the software, a program constituting the software is installed on a computer. Here, examples of the computer include a computer incorporated in dedicated hardware, and for example, a general-purpose personal computer capable of executing various functions by installing various programs.

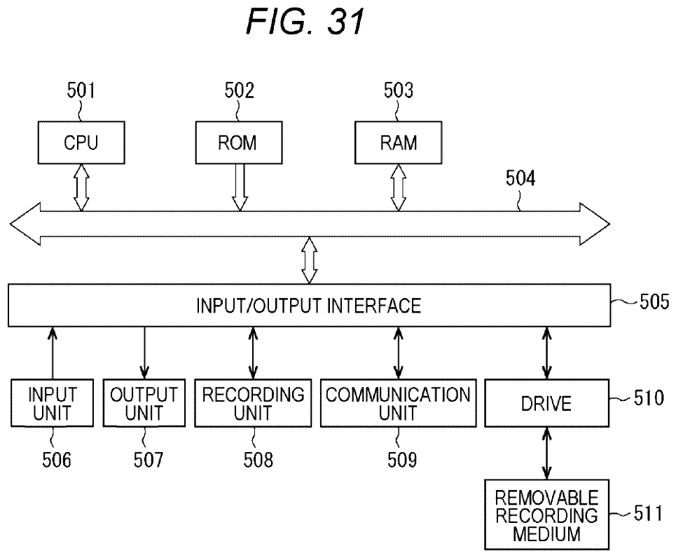

FIG. 31 is a block diagram illustrating a configuration example of hardware of a computer that executes the above-described series of processing by a program.

In the computer, a central processing unit (CPU) 501, a read only memory (ROM) 502, and a random access memory (RAM) 503 are mutually connected by a bus 504.

Moreover, an input/output interface 505 is connected to the bus 504. An input unit 506, an output unit 507, a recording unit 508, a communication unit 509, and a drive 510 are connected to the input/output interface 505.

The input unit 506 includes a keyboard, a mouse, a microphone, an imaging element, and the like. The output unit 507 includes a display, a speaker, and the like. The recording unit 508 includes a hard disk, a non-volatile memory, and the like. The communication unit 509 includes a network interface and the like. The drive 510 drives a removable recording medium 511 such as a magnetic disk, an optical disk, a magneto-optical disk, or a semiconductor memory.

In the computer configured as described above, the CPU 501 loads, for example, a program recorded in the recording unit 508 into the RAM 503 via the input/output interface 505 and the bus 504, and executes the program, so as to execute the above-described series of processing.

The program executed by the computer (CPU 501) can be provided by being recorded on the removable recording medium 511 as a package medium, or the like, for example. Furthermore, the program can be provided via a wired or wireless transmission medium such as a local area network, the Internet, or digital satellite broadcasting.

In the computer, the program can be installed in the recording unit 508 via the input/output interface 505 by mounting the removable recording medium 511 to the drive 510. Furthermore, the program can be received by the communication unit 509 via the wired or wireless transmission medium to be installed on the recording unit 508. In addition, the program can be installed in the ROM 502 or the recording unit 508 in advance.

Note that the program executed by the computer may be a program for processing in time series in the order described herein, or a program for processing in parallel or at a necessary timing such as when a call is made.

Furthermore, the embodiments of the present technology are not limited to the above-described embodiments, and various modifications are possible without departing from the scope of the present technology. For example, as the embodiment of the present technology, an example has been described in which the quantization processing is executed in descending order of the priority of the object. However, the quantization processing may be executed in ascending order of the priority of the object depending on a use case.

For example, the present technology may be configured as cloud computing in which one function is shared by a plurality of devices via the network to process together.

Furthermore, each of the steps in the flowcharts described above can be executed by one device or executed by a plurality of devices in a shared manner.

Moreover, in a case where a plurality of processing is included in a single step, the plurality of processing included in the single step can be performed by one device or be performed by a plurality of devices in a shared manner.

Moreover, the present technology may also have following configurations.

(1)

An encoding device including:
a priority information generation unit that generates priority information indicating a priority of an audio signal, on the basis of at least one of the audio signal or metadata of the audio signal;
a time-frequency transform unit that performs time-frequency transform on the audio signal and generates an MDCT coefficient; and
a bit allocation unit that quantizes the MDCT coefficient of the audio signal, in descending order of the priority of the audio signal indicated by the priority information, for a plurality of the audio signals.
   (2)

The encoding device according to (1), in which
the bit allocation unit executes minimum quantization processing on the MDCT coefficients of the plurality of the audio signals and executes additional quantization processing for quantizing the MDCT coefficient on the basis of a result of the minimum quantization processing in descending order of the priority of the audio signal indicated by the priority information.
   (3)

The encoding device according to (2), in which
in a case where the bit allocation unit is not able to execute the additional quantization processing on all the audio signals within a predetermined time limit, the bit allocation unit outputs a result of the minimum quantization processing as a quantization result of the audio signal on which the additional quantization processing is not completed.
   (4)

The encoding device according to (3), in which
the bit allocation unit executes the minimum quantization processing in descending order of the priority of the audio signal indicated by the priority information.
   (5)

The encoding device according to (4), in which
in a case where the bit allocation unit is not able to execute the minimum quantization processing on all the audio signals within the time limit, the bit allocation unit outputs a quantized value of zero data, as a quantization result of the audio signal on which the minimum quantization processing is not completed.
   (6)

The encoding device according to (5), in which
the bit allocation unit further outputs mute information indicating whether or not the quantization result of the audio signal is the quantized value of the zero data.
   (7)

The encoding device according to any one of (3) to (6), in which
the bit allocation unit determines the time limit on the basis of a processing time needed in a subsequent stage of the bit allocation unit.
   (8)

The encoding device according to (7), in which
the bit allocation unit dynamically changes the time limit, on the basis of the result of the minimum quantization processing executed so far or the result of the additional quantization processing.
   (9)

The encoding device according to any one of (2) to (8), in which
the priority information generation unit generates the priority information, on the basis of a sound pressure of the audio signal, a spectral shape of the audio signal, or a correlation of the spectral shapes of the plurality of the audio signals.
   (10)

The encoding device according to any one of (2) to (9), in which
the metadata includes a Priority value indicating a priority of the audio signal generated in advance.
   (11)

The encoding device according to any one of (2) to (10), in which
the metadata includes position information indicating a sound source position of sound based on the audio signal, and
the priority information generation unit generates the priority information on the basis of at least the position information and listening position information indicating a user's listening position.
   (12)

The encoding device according to any one of (2) to (11), in which
the plurality of the audio signals includes at least one of the audio signal of an object or the audio signal of a channel.
   (13)

The encoding device according to any one of (2) to (12), further including:
an auditory psychological parameter calculation unit that calculates an auditory psychological parameter on the basis of the audio signal, in which
the bit allocation unit executes the minimum quantization processing and the additional quantization processing, on the basis of the auditory psychological parameter.
   (14)

The encoding device according to any one of (2) to (13), further including:
an encoding unit that encodes the quantization result of the audio signal, output from the bit allocation unit.
   (15)

The encoding device according to (13), in which
the auditory psychological parameter calculation unit calculates the auditory psychological parameter on the basis of the audio signal and setting information regarding a masking threshold for the audio signal.
   (16)

An encoding method by an encoding device, including:
generating priority information indicating a priority of an audio signal, on the basis of at least one of the audio signal or metadata of the audio signal;
performing time-frequency transform on the audio signal and generating an MDCT coefficient; and
quantizing the MDCT coefficient of the audio signal, in descending order of the priority of the audio signal indicated by the priority information, for a plurality of the audio signals.
   (17)

A program for causing a computer to execute processing including:
generating priority information indicating a priority of an audio signal, on the basis of at least one of the audio signal or metadata of the audio signal;
performing time-frequency transform on the audio signal and generating an MDCT coefficient; and
quantizing the MDCT coefficient of the audio signal, in descending order of the priority of the audio signal indicated by the priority information, for a plurality of the audio signals.
   (18)

A decoding device including:
a decoding unit that acquires an encoded audio signal obtained by quantizing an MDCT coefficient of an audio signal, in descending order of a priority of the audio signal indicated by priority information generated on the basis of at least one of the audio signal or metadata of the audio signal, for a plurality of the audio signals, and decodes the encoded audio signal.
   (19)

The decoding device according to (18), in which
the decoding unit further acquires mute information indicating whether or not a quantization result of the audio signal is a quantized value of zero data, and generates the audio signal on the basis of the MDCT coefficient obtained by decoding or generates the audio signal as setting the MDCT coefficient to zero, according to the mute information.
   (20)

A decoding method by a decoding device including:
acquiring an encoded audio signal obtained by quantizing an MDCT coefficient of an audio signal, in descending order of a priority of the audio signal indicated by priority information generated on the basis of at least one of the audio signal or metadata of the audio signal, for a plurality of the audio signals; and decoding the encoded audio signal.
   (21)

A program for causing a computer to execute processing including:
acquiring an encoded audio signal obtained by quantizing an MDCT coefficient of an audio signal, in descending order of a priority of the audio signal indicated by priority information generated on the basis of at least one of the audio signal or metadata of the audio signal, for a plurality of the audio signals; and
decoding the encoded audio signal.
   (22)

An encoding device including:
an encoding unit that encodes an audio signal and generates an encoded audio signal;
a buffer that holds a bit stream including the encoded audio signal for each frame; and
an insertion unit that inserts encoded silent data generated in advance into the bit stream, as the encoded audio signal of a frame to be processed, in a case where processing for encoding the audio signal is not completed within a predetermined time for the frame to be processed.
   (23)

The encoding device according to (22), further including:
a bit allocation unit that quantizes an MDCT coefficient of the audio signal, in which
the encoding unit encodes a quantization result of the MDCT coefficient.
   (24)

The encoding device according to (23), further including:
a generation unit that generates the encoded silent data.
   (25)

The encoding device according to (24), in which
the generation unit generates the encoded silent data by encoding a quantized value of an MDCT coefficient of silent data.
   (26)

The encoding device according to (24) or (25), in which
the generation unit generates the encoded silent data on the basis of only the silent data for one frame.
   (27)

The encoding device according to any one of (24) to (26), in which
the audio signal includes an audio signal of a channel or an object, and
the generation unit generates the encoded silent data, on the basis of at least one of the number of channels or the number of objects.
   (28)

The encoding device according to any one of (22) to (27), in which
the insertion unit inserts the encoded silent data according to a type of the frame to be processed.
   (29)

The encoding device according to (28), in which
in a case where the frame to be processed is a preroll frame of a randomly accessible frame, the insertion unit inserts the encoded silent data into the bit stream as the encoded audio signal of the preroll frame regarding the randomly accessible frame.
   (30)

The encoding device according to (28) or (29), in which
in a case where the frame to be processed is a randomly accessible frame, the insertion unit inserts the encoded silent data into the bit stream as the encoded audio signal of the preroll frame of the frame to be processed.
   (31)

The encoding device according to any one of (23) to (27), in which
in a case where the processing for encoding the audio signal is completed within the predetermined time if the bit allocation unit executes only minimum quantization processing on the MDCT coefficient or terminates additional quantization processing, to be executed after the minimum quantization processing on the MDCT coefficient halfway, the insertion unit does not insert the encoded silent data.
   (32)

The encoding device according to any one of (22) to (31), in which
the encoding unit performs variable length encoding on the audio signal.
   (33)

The encoding device according to (32), in which
the variable length encoding is context-based arithmetic coding.
   (34)

An encoding method by an encoding device including:
encoding an audio signal and generating an encoded audio signal;
holding a bit stream including the encoded audio signal for each frame in a buffer; and
inserting encoded silent data generated in advance into the bit stream as the encoded audio signal of a frame to be processed, in a case where processing for encoding the audio signal is not completed with a predetermined time, for the frame to be processed.
   (35)

A program for causing a computer to execute processing including:
encoding an audio signal and generating an encoded audio signal;
holding a bit stream including the encoded audio signal for each frame in a buffer; and
inserting encoded silent data generated in advance into the bit stream as the encoded audio signal of a frame to be processed, in a case where processing for encoding the audio signal is not completed with a predetermined time, for the frame to be processed.
   (36)

A decoding device including:
a decoding unit that encodes an audio signal and generates an encoded audio signal, acquires a bit stream obtained by inserting encoded silent data generated in advance, as the encoded audio signal of a frame to be processed into the bit stream including the encoded audio signal for each frame, in a case where the processing for encoding the audio signal is not completed within a predetermined time, for the frame to be processed, and decodes the encoded audio signal.
   (37)

A decoding method by a decoding device, including:
encoding an audio signal and generating an encoded audio signal, acquiring a bit stream obtained by inserting encoded silent data generated in advance, as the encoded audio signal of a frame to be processed into the bit stream including the encoded audio signal for each frame, in a case where the processing for encoding the audio signal is not completed within a predetermined time, for the frame to be processed, and decoding the encoded audio signal.
   (38)

A program for causing a computer to execute processing including:
encoding an audio signal and generating an encoded audio signal, acquiring a bit stream obtained by inserting encoded silent data generated in advance, as the encoded audio signal of a frame to be processed into the bit stream including the encoded audio signal for each frame, in a case where the processing for encoding the audio signal is not completed within a predetermined time, for the frame to be processed, and decoding the encoded audio signal.
   (39)

An encoding device including:
a time-frequency transform unit that performs time-frequency transform on an audio signal of an object and generates an MDCT coefficient;
an auditory psychological parameter calculation unit that calculates an auditory psychological parameter on the basis of the MDCT coefficient and setting information regarding a masking threshold for the object; and
a bit allocation unit that executes bit allocation processing on the basis of the auditory psychological parameter and the MDCT coefficient and generates a quantized MDCT coefficient.
   (40)

The encoding device according to (39), in which
the setting information includes information indicating an upper limit value of the masking threshold set for each frequency.
   (41)

The encoding device according to (39) or (40), in which
the setting information includes information indicating an upper limit value of the masking threshold set for each of one or a plurality of the objects.
   (42)

An encoding method by an encoding device, including:
performing time-frequency transform on an audio signal of an object and generating an MDCT coefficient;
calculating an auditory psychological parameter on the basis of the MDCT coefficient and setting information regarding a masking threshold for the object; and
executing bit allocation processing on the basis of the auditory psychological parameter and the MDCT coefficient and generating a quantized MDCT coefficient.
   (43)

A program for causing a computer to execute processing including steps including:
performing time-frequency transform on an audio signal of an object and generating an MDCT coefficient;
calculating an auditory psychological parameter on the basis of the MDCT coefficient and setting information regarding a masking threshold for the object; and
executing bit allocation processing on the basis of the auditory psychological parameter and the MDCT coefficient and generating a quantized MDCT coefficient.

### REFERENCE SIGNS LIST

11 Encoder
21 Object metadata encoding unit
22 Object audio encoding unit
23 Packing unit
51 Priority information generation unit
52 Time-frequency transform unit
53 Auditory psychological parameter calculation unit
54 Bit allocation unit
55 Encoding unit
81 Decoder
91 Unpacking/decoding unit
92 Rendering unit
331 Context processing unit
332 Variable length encoding unit
333 Output buffer
334 Processing progress monitoring unit
335 Processing completion availability determination unit
336 Encoded Mute data insertion unit
362 Encoded Mute data generation unit

1. An encoding device comprising:
a priority information generation unit configured to generate priority information indicating a priority of an audio signal, on a basis of at least one of the audio signal or metadata of the audio signal;
a time-frequency transform unit configured to perform time-frequency transform on the audio signal and generate an MDCT coefficient; and
a bit allocation unit configured to quantize the MDCT coefficient of the audio signal, in descending order of the priority of the audio signal indicated by the priority information, for a plurality of the audio signals.

2. The encoding device according to claim 1, wherein
the bit allocation unit executes minimum quantization processing on the MDCT coefficients of the plurality of the audio signals and executes additional quantization processing for quantizing the MDCT coefficient on a basis of a result of the minimum quantization processing in descending order of the priority of the audio signal indicated by the priority information.

3. The encoding device according to claim 2, wherein
in a case where the bit allocation unit is not able to execute the additional quantization processing on all the audio signals within a predetermined time limit, the bit allocation unit outputs a result of the minimum quantization processing as a quantization result of the audio signal on which the additional quantization processing is not completed.

4. The encoding device according to claim 3, wherein
the bit allocation unit executes the minimum quantization processing in descending order of the priority of the audio signal indicated by the priority information.

5. The encoding device according to claim 4, wherein
in a case where the bit allocation unit is not able to execute the minimum quantization processing on all the audio signals within the time limit, the bit allocation unit outputs a quantized value of zero data, as a quantization result of the audio signal on which the minimum quantization processing is not completed.

6. The encoding device according to claim 5, wherein
the bit allocation unit further outputs mute information indicating whether or not the quantization result of the audio signal is the quantized value of the zero data.

7. The encoding device according to claim 3, wherein
the bit allocation unit determines the time limit on a basis of a processing time needed in a subsequent stage of the bit allocation unit.

8. The encoding device according to claim 7, wherein
the bit allocation unit dynamically changes the time limit, on a basis of the result of the minimum quantization processing executed so far or the result of the additional quantization processing.

9. The encoding device according to claim 2, wherein
the priority information generation unit generates the priority information, on a basis of a sound pressure of the audio signal, a spectral shape of the audio signal, or a correlation of the spectral shapes of the plurality of the audio signals.

10. The encoding device according to claim 2, wherein
the metadata includes a Priority value indicating a priority of the audio signal generated in advance.

11. The encoding device according to claim 2, wherein
the metadata includes position information indicating a sound source position of sound based on the audio signal, and
the priority information generation unit generates the priority information on a basis of at least the position information and listening position information indicating a user's listening position.

12. The encoding device according to claim 2, wherein
the plurality of the audio signals includes at least one of the audio signal of an object or the audio signal of a channel.

13. The encoding device according to claim 2, further comprising:
an auditory psychological parameter calculation unit configured to calculate an auditory psychological parameter on a basis of the audio signal, wherein
the bit allocation unit executes the minimum quantization processing and the additional quantization processing, on a basis of the auditory psychological parameter.

14. The encoding device according to claim 2, further comprising:
an encoding unit configured to encode a quantization result of the audio signal, output from the bit allocation unit.

15. The encoding device according to claim 13, wherein
the auditory psychological parameter calculation unit calculates the auditory psychological parameter on a basis of the audio signal and setting information regarding a masking threshold for the audio signal.

16. (canceled)

17. (canceled)

18. A decoding device comprising:
a decoding unit configured to acquire an encoded audio signal obtained by quantizing an MDCT coefficient of an audio signal, in descending order of a priority of the audio signal indicated by priority information generated on a basis of at least one of the audio signal or metadata of the audio signal, for a plurality of the audio signals, and decode the encoded audio signal.

19. The decoding device according to claim 18, wherein
the decoding unit further acquires mute information indicating whether or not a quantization result of the audio signal is a quantized value of zero data, and generates the audio signal on a basis of the MDCT coefficient obtained by decoding or generates the audio signal as setting the MDCT coefficient to zero, according to the mute information.

20. (canceled)

21. (canceled)

22. An encoding device comprising:
an encoding unit configured to encode an audio signal and generate an encoded audio signal;
a buffer configured to hold a bit stream including the encoded audio signal for each frame; and
an insertion unit configured to insert encoded silent data generated in advance into the bit stream, as the encoded audio signal of a frame to be processed, in a case where processing for encoding the audio signal is not completed within a predetermined time for the frame to be processed.

23. The encoding device according to claim 22, further comprising:
a bit allocation unit configured to quantize an MDCT coefficient of the audio signal, wherein
the encoding unit encodes a quantization result of the MDCT coefficient.

24. The encoding device according to claim 23, further comprising:
a generation unit configured to generate the encoded silent data.

25. The encoding device according to claim 24, wherein
the generation unit generates the encoded silent data by encoding a quantized value of an MDCT coefficient of silent data.

26. The encoding device according to claim 24, wherein
the generation unit generates the encoded silent data on a basis of only the silent data for one frame.

27. The encoding device according to claim 24, wherein
the audio signal includes an audio signal of a channel or an object, and
the generation unit generates the encoded silent data, on a basis of at least one of the number of channels or the number of objects.

28. The encoding device according to claim 22, wherein
the insertion unit inserts the encoded silent data according to a type of the frame to be processed.

29. The encoding device according to claim 28, wherein
in a case where the frame to be processed is a preroll frame of a randomly accessible frame, the insertion unit inserts the encoded silent data into the bit stream as the encoded audio signal of the preroll frame regarding the randomly accessible frame.

30. The encoding device according to claim 28, wherein
in a case where the frame to be processed is a randomly accessible frame, the insertion unit inserts the encoded silent data into the bit stream as the encoded audio signal of a preroll frame of the frame to be processed.

31. The encoding device according to claim 23, wherein
in a case where the processing for encoding the audio signal is completed within the predetermined time if the bit allocation unit executes only minimum quantization processing on the MDCT coefficient or terminates additional quantization processing, to be executed after the minimum quantization processing on the MDCT coefficient, halfway, the insertion unit does not insert the encoded silent data.

32. The encoding device according to claim 22, wherein
the encoding unit performs variable length encoding on the audio signal.

33. The encoding device according to claim 32, wherein
the variable length encoding is context-based arithmetic coding.

34. (canceled)

35. (canceled)

36. A decoding device comprising:
a decoding unit configured to encode an audio signal and generate an encoded audio signal, acquire a bit stream obtained by inserting encoded silent data generated in advance, as the encoded audio signal of a frame to be processed into the bit stream including the encoded audio signal for each frame, for the frame to be processed, in a case where the processing for encoding the audio signal is not completed within a predetermined time, and decode the encoded audio signal.

37. (canceled)

38. (canceled)

39. An encoding device comprising:
a time-frequency transform unit configured to perform time-frequency transform on an audio signal of an object and generate an MDCT coefficient;
an auditory psychological parameter calculation unit configured to calculate an auditory psychological parameter on a basis of the MDCT coefficient and setting information regarding a masking threshold for the object; and
a bit allocation unit configured to execute bit allocation processing on a basis of the auditory psychological parameter and the MDCT coefficient and generate a quantized MDCT coefficient.

40. The encoding device according to claim 39, wherein
the setting information includes information indicating an upper limit value of the masking threshold set for each frequency.

41. The encoding device according to claim 39, wherein
the setting information includes information indicating an upper limit value of the masking threshold set for each of one or a plurality of the objects.

42. (canceled)

43. (canceled)
